(19) United States
(12) Patent Application Publication
(10) Pub. No.: US 2026/0225394 A1
(43) Pub. Date: Aug. 6, 2026

(54) ENERGY CONVERTING PARTICLES AND METHODS FOR THEIR USE IN SECURITY, ANTICOUNTERFEITING, AND ANTI-TAMPERING END-USES

(71) Applicant: Immunolight, LLC, Detroit, MI (US)

(72) Inventors: Zakaryae FATHI, Raleigh, NC (US); Harold WALDER, Oak Island, NC (US); Frederic A. BOURKE, Jr., Aspen, CO (US); Wayne F. BEYER, Jr., Ivanhoe, VA (US)

(73) Assignee: Immunolight, LLC, Detroit, MI (US)

(21) Appl. No.: 19/150,366

(22) PCT Filed: Jan. 23, 2024
(86) PCT No.: PCT/US2024/012609

§ 371 Date: Jul. 23, 2025

Related U.S. Application Data
(60) Provisional application No. 63/481,441, filed on Jan. 25, 2023.
(60) Provisional application No. 63/481,684, filed on Jan. 26, 2023.

(51) Int. Cl. B42D 25/387; B41M 3/14; B42D 25/28; B42D 25/382; C09D 11/50

(52) U.S. Cl. CPC B42D 25/387; B41M 3/144; B42D 25/28; B42D 25/382; C09D 11/50

(57) ABSTRACT

A method for security marking of an article is provided. The method includes the step of providing a marking composition. The marking composition includes one or more energy converters which emit UV and/or visible light upon interaction with an applied external energy, and, optionally, a carrier. The marking composition is applied onto at least a part of a surface of the article.

### CROSS REFERENCE TO RELATED APPLICATIONS

This application is related to, and claims priority to, provisional application U.S. Ser. No. 63/481,441, filed Jan. 25, 2023, entitled ENERGY CONVERTING PARTICLES AND METHODS FOR THEIR USE IN SECURITY, ANTICOUNTERFEITING, AND ANTI-TAMPERING END-USES, the entire disclosure of which is incorporated herein by reference. This application is related to, and claims priority to, provisional application U.S. Ser. No. 63/481,684, filed Jan. 26, 2023, entitled ENERGY CONVERTING PARTICLES AND METHODS FOR THEIR USE IN SECURITY, ANTICOUNTERFEITING, AND ANTI-TAMPERING END-USES, the entire disclosure of which is incorporated herein by reference.

### BACKGROUND OF THE INVENTION

### Field of the Invention

The present invention relates to the use of energy conversion and energy converting particles in various security, anticounterfeiting and anti-tampering applications.

### Description of the Related Art

Counterfeiting is a significant problem in many industries worldwide, resulting in hundreds of billions of dollars of lost revenues annually in industries such as pharmaceuticals, cosmetics and fragrances, textiles and clothing, food, luxury goods, consumer products, electronics, paints, inks, currency and packaging, to name a few. The pharmaceutical industry has a particular problem dealing with counterfeit products, with the World Health Organization estimating approximately $431 billion in counterfeit pharmaceutical products sold each year. In addition to lost revenues, counterfeiting of pharmaceuticals also involves a significant health and safety risk for millions of people. Many counterfeit pharmaceuticals are found to include either only inactive ingredients or dangerous impurities, and counterfeiting is a significant problem across all pharmaceutical classes including branded, generic and OTC products and in all dosage forms including orals, injectables and topicals. In fact, due to the significant public health risks involved, many regulatory agencies have made introduction of anti-counterfeiting standards and policies a top priority.

Worldwide, regulatory agencies have been and continue targeting introduction of significantly higher standards in “track and trace” capabilities in pharmaceutical manufacturing, which are likely to significantly change pharmaceutical development and manufacturing going forward. Already in the United States, counterfeiting has led FDA to publish a Guidance for Industry entitled Incorporation of Physical Chemical Identifiers (PCIDs) into Solid Oral Dosage Form Drug Products for Anti-Counterfeiting (2011). In addition, the Drug Quality and Security Act was passed into law in 2013, and outlines steps to build a system to identify and trace prescription drugs through their distribution chain. Some of the key aspects of the law outline requirements related to the use of lot numbers, expiration dates, bar codes and other unique identifiers.

While technologies based on encrypting either the label/package or the product can provide some benefits, they cannot conclusively demonstrate that both product and label are authentic at any stage in the supply chain or when the product is removed from packaging. Despite many options for authentication including imprints, colorants, electronic microchips, inert materials and other alternatives, counterfeiting remains a major problem in pharmaceutical manufacturing, for the following reasons:
There is no direct link between drug and product. Many current technologies work on either the label or the product, but not on both. In such cases, this interferes with the ability to confirm that the product and label are the same unit at every stage in the supply chain.
The technology is difficult and expensive to implement. Technologies that tag both product and label frequently require costly and time-consuming remote authentication, while the industry needs an immediate on-site process that provides a real-time link between product and package to ensure that both are authentic. Further, technologies that tag product can introduce additional steps and costs to the manufacturing process.
Visibility. There are a variety of options to tag both product and labeling that are readily visible, making them easier for counterfeiters to work around. On the other hand, others that are not readily visible to the naked eye cannot be easily visually inspected in the field. Accordingly, a tag and trace capability is needed that is based on visible and invisible inert materials that can be observed and verified on demand at any stage in the supply chain.
Materials added to drug formulations. Materials used for authentication must be inert and cannot adversely affect the manufacturing process or pharmaceutical properties.

According to the FDA Guidance for Physical Chemical Identifiers (PCIDs), the materials used to support authentication protocols:
must be pharmacologically inactive;
must be “a substance or combination of substances possessing a unique physical or chemical property that unequivocally identified a drug product”;
must not affect identity, strength, quality, purity, potency or bioavailability, and
may rely on previously established safety criteria if included on either the GRAS list for food additives or the database of inactive ingredients for approved drug products.

One solution that has been proposed is by Taaneh, Inc. (of Princeton, NJ; www.taaneh.com), which uses nanoparticulate diamond, which has been found to emit infrared light upon exposure to UV. Through the use of such diamond particles, and a specially designed detection device which emits UV and detects IR emissions, products and packaging can be marked and detected. According to Taaneh, the diamond particles exist in the form of lattices which can possess variations in structure that make them unique, and when exposed to light they emit spectral signatures belonging to them alone, creating a distinct birthmark of sorts. However, it would appear that in order to generate identifiers with more complex signatures, or signatures which convey additional information beyond a signature, such as manufacturing data, product properties, packaging properties, etc, the use of such diamond particles would be insufficient absent costly production of many different types of diamond particles under highly controlled conditions.

A further solution has been proposed by Systech International (based in Princeton, NJ; www.systechone.com) which uses existing printing operations on packaging. The Systech system is based on the small variabilities present in any printing operation, particularly the printing of complex color schemes, images, barcodes, etc., which result in unique signatures on packaging print. These signatures can be acquired at the time of production, stored in a cloud based database, then detected at the point of use, to provide authentication when compared to the stored data from time of production. One pitfall, however, is that this system is more difficult, if not impossible, to implement in marking of the pharmaceutical drug itself, since printing is either nonexistent or non-complex on most pharmaceutical drug products.

Accordingly, a solution is needed for the security marking and authentication of articles, particularly pharmaceuticals, which has increased flexibility in terms of information conveyed, but which can be readily detected with existing UV/vis/IR emission detectors.

### SUMMARY OF THE INVENTION

One object of the present invention is to provide methods and marking compositions for use in marking products to increase product security, authenticity, and/or provide anti-counterfeiting properties to the marked products.

A further object of the present invention is to authenticate products with one or more marking compositions, wherein each marking composition comprises one or more energy converters configured to generate signature light emissions from the product for security applications. For example, a pattern of marking compositions may be arranged on a luxury product, and upon the application of external energy, the pattern of marking compositions will emit the signature light emission that may verify the origin/authenticity of the luxury product.

Another object of the invention is to mark products with marking compositions to convey information about the product upon exposure to external energy. For example, a products origin, manufacturing date, and other information may be conveyed based on the signature light emission from the marking compositions.

Another object of the invention is to produce a product comprising marking compositions to convey information about the product upon exposure to external energy. For example, in some embodiments, the marking compositions may be applied to a surface of the product after the product has been produced. In other embodiments, the marking compositions may be added to the raw materials used to produce the product such that the marking compositions are dispersed within the final product. For example, the product may be a plastic container made through injection molding. The marking compositions may be added to the raw materials used for the injection molding such that the final product comprises the marking compositions throughout the product.

Another object of the invention is to mark pharmaceutical and/or food products with marking compositions to authenticate the pharmaceutical and/or food products. In such embodiments, the marking compositions may comprise a biocompatible material such that the marking compositions can be consumed with the pharmaceutical and/or food products.

Another object of the invention is to mark credit cards with marking compositions to provide another layer of security to prevent credit card theft.

Another object of the invention is to mark packages within a shipping container with marking compositions such that upon the application of an external energy on the shipping container, the marking compositions on each package can emit a signature light emission that can be received and processed outside of the shipping container. Thus, information about the packages within the shipping container can be conveyed without opening the shipping container.

These and other objects and advantages of the invention, either alone or in combinations thereof, may be satisfied by a method for security marking of an article, comprising the steps of:
(a) determining a desired pattern of marking compositions to encode an article with desired information, the marking compositions comprising one or more energy converters which emit UV and/or visible light upon interaction with an applied external energy;
(b) selecting the appropriate energy converters for the marking compositions to achieve the desired pattern comprising the desired information;
(c) applying the appropriate energy converters in the desired pattern to mark the article with the pattern of marking compositions; and
(d) applying external energy to the article and reading the emitted light information from the marking compositions to verify that the desired pattern of marking compositions conveys the desired information.

In further embodiments, these and other objects and advantages of the invention, either alone or in combinations thereof, have been satisfied by a method for security marking of an article, comprising:
(a) providing a marking composition comprising one or more energy converters which emit UV and/or visible light upon interaction with an applied external energy, and, optionally, a carrier; and
(b) applying the marking composition onto at least a part of a surface of the article.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A illustrates a top view of some embodiments of a pharmaceutical pill marked with a marking composition comprising energy converters.

FIG. 1B illustrates a side view of some embodiments of the pharmaceutical pill when the marking composition is arranged within the pharmaceutical pill.

FIG. 1C illustrates a side view of some embodiments of the pharmaceutical pill when the marking composition is arranged on an outer surface of the pharmaceutical pill.

FIG. 2 illustrates a top view of some embodiments of a pharmaceutical pill marked with a sequence of marking compositions.

FIG. 3 presents a depicting the various colors of visible light that may be emitted from each marking composition when exposed to radiation.

FIG. 4 illustrates a cross-sectional view of some embodiments of a pill bottle marked with a marking composition and containing pharmaceutical pills marked with a marking composition.

FIG. 5 illustrates a perspective view of some embodiments of a pill bottle comprising a sealing structure, the sealing structure marked with an array of marking compositions.

FIG. 6 illustrates some embodiments of a handbag marked with a marking composition.

FIG. 7 illustrates some embodiments of a shoe marked with a marking composition.

FIG. 8 illustrates some embodiments of a label comprising an array of marking compositions.

FIG. 9 illustrates some embodiments of a cylindrical label comprising an array of marking compositions.

FIG. 10A and FIG. 10B illustrate some embodiments of the cylindrical label of FIG. 9 and coupled to a tag attachment.

FIG. 11 illustrates a schematic of a shipping container comprising various packages each marked with a marking composition.

FIG. 12 illustrates some embodiments of a lookup table that defines a manufacturing date and a manufacturing site for a product marked with a sequence of marking compositions based on the marking composition's location on each product and emitted color.

FIG. 13 illustrates some embodiments of an adhesive label comprising an array of marking compositions.

FIG. 14 illustrates some embodiments of a label comprising both an array of marking compositions and antennae.

FIG. 15 illustrates some embodiments of a label comprising both an array of marking compositions and an RFID chip.

FIG. 16 and FIG. 17 illustrate some embodiments of a method of applying the marking compositions to a pharmaceutical pill.

FIG. 18 illustrates some embodiments of an application apparatus for applying a sequence of marking compositions to a pharmaceutical pill.

FIG. 19 illustrates a flow-chart of an exemplary method of marking a pharmaceutical pill with a marking composition.

### DETAILED DESCRIPTION OF THE PREFERRED EMBODIMENTS

Referring now to the drawings, wherein like reference numerals designate identical or corresponding parts throughout the several views.

One embodiment of the present invention provides a method for security marking of an article. The method includes providing a marking composition comprising one or more energy converters which emit UV and/or visible light upon interaction with an applied external energy, and, optionally, a carrier; and applying the marking composition onto at least a part of a surface of the article. The marking composition would not be visible without exposure to the external energy.

This method can be used to perform security marking of any desired article, including, but not limited to, pharmaceutical drugs, food, clothing, handbags, shoes, packaging, bottles, and portions of containers, medical devices, boxes, shipping crates, shipping containers (such as those transported on container ships or trains), etc.

### Pharmaceutical Anticounterfeiting

In one embodiment, the present invention relates to the use of energy converters to provide protection against pharmaceutical counterfeiting, both for the drugs and their packaging. The pharmaceutical drug forms protected can be any desired form, including, but not limited to tablets, caplets, capsules, liquid/gel capsules, consumable liquids, topical ointments, and injectables.

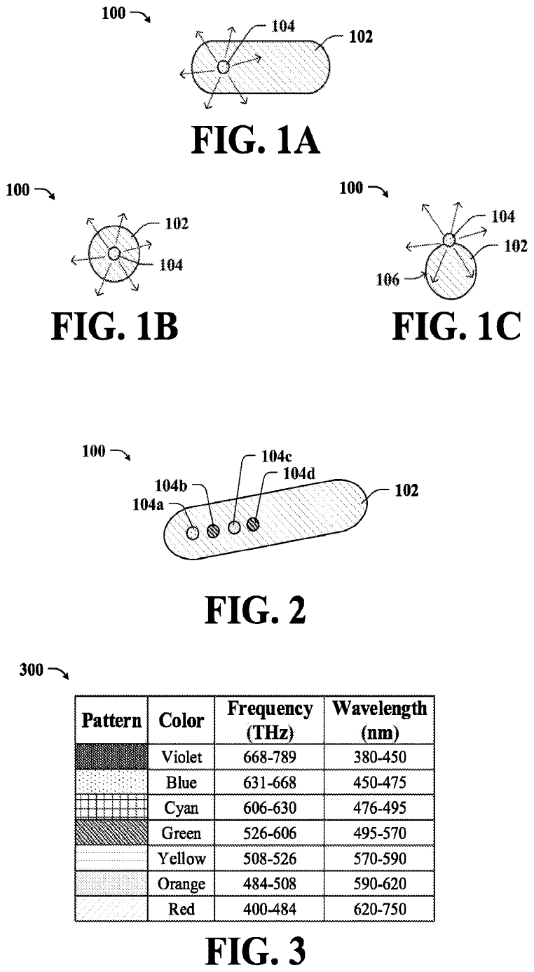

Referring to FIG. 1A, an exemplary marked pharmaceutical pill 100 according to one embodiment is illustrated. In some embodiments, the marked pharmaceutical pill 100 comprises a pill body 102 containing a pharmaceutical drug. The pill body 102 is marked with a marking composition 104. The marking composition 104 comprises one or more energy converters that absorb an applied radiation and emit a defined emission wavelength, combination of wavelengths, or wavelength spectrum. Therefore, when radiation is applied to the marked pharmaceutical pill 100 in FIG. 1A, the marking composition 104 will emit a defined emission wavelength, combination of wavelengths, or wavelength spectrum that can authenticate the origin of the marked pharmaceutical pill 100. Dotted arrows are used throughout the Figures to illustrate the emitted wavelength(s) from the marking composition 104. It will be appreciated that the number and/or size of the dotted arrows is arbitrary.

When marking the pharmaceutical pill 100, the placement of the marking composition 104 may be in any desired location on, or even in, the pill body 102 (it is noted that the pill body 102 may be a solid pill, a capsule, or other pharmaceutical delivery form). For example, as shown in FIG. 1B, the marking composition 104 may be arranged within the pill body 102 and thus, suspended within the pharmaceutical drug composition. In such embodiments, the marking composition 104 may be added to the pharmaceutical drug composition prior to formation of the pill body 102. For example, the marking composition 104 may be added as admixture with a dry form of the pharmaceutical drug composition, or added in suspension in a liquid form of the pharmaceutical drug composition.

As shown in FIG. 1C, in some other embodiments, the marking composition 104 may be arranged on an outer surface 106 of the pill body 102. In such embodiments, the pill body 102 may be marked with the marking composition 104 after the pill body 102 was formed. Further, if the pill body 102 is a capsule that contains the pharmaceutical drug composition, the marking composition 104 may be formed on an interior surface of the capsule of the pill body 102.

It will be appreciated that in other embodiments, the marked pharmaceutical pill 100 may be in a form other than a pill or capsule. For example, in some other embodiments, the marking composition 104 may be added to a topical ointment, a liquid, or some other pharmaceutical drug form.

When used in a pharmaceutical context where the marking composition 104 is integrated with a pharmaceutical drug composition that will be administered to a patient, the energy converters in the marking composition 104 are preferably coated with a biocompatible or bioinert coating or coatings, including, but not limited to, ethyl cellulose, diamond, diamond-like carbon, etc. Alternatively, the energy converter in the marking composition 104 can be a biocompatible or bioinert substance.

Referring now to FIG. 2, in some embodiments, the marked pharmaceutical pill 100 may comprise several marking compositions 104. For example, in FIG. 2, a first marking composition 104a, a second marking composition 104b, a third marking composition 104c, and a fourth marking composition 104d are all spaced apart from one another and arranged on the pill body 102. The arrangement of the multiple marking compositions 104a-d may be in the form of a line as shown in FIG. 2 or may be in some other form such as a two-by-two array or a QR code.

In some embodiments, each marking composition 104a-d may correspond to a desired emitted color or wavelength upon exposure to radiation. For example, FIG. 3 illustrates a table 300 presents the frequency and wavelength of colored visible light. The “color” presented in FIG. 3 also corresponds to a particular shading pattern throughout the drawings of this application. As will be discussed later, one or more of the marking compositions 104a-d may alternatively or additionally emit wavelengths or wavelength spectra in the ultraviolet and/or infrared spectrums.

Each marking composition 104a-d in FIG. 2 may comprise an energy converter that corresponds to some desired color of visible light upon exposure to radiation. For example, when comparing the pattern of each marking composition 104a-d in FIG. 2 with the table 300 presented in FIG. 3, the first marking composition 104a comprises an energy converter that is configured to emit blue light; the second marking composition 104b comprises an energy converter that is configured to emit green light; the third marking composition 104c comprises an energy converter that is configured to emit orange light; and the fourth marking composition 104d comprises an energy converter that is configured to emit green light. Thus, when the marked pharmaceutical pill 100 of FIG. 2 is exposed to radiation, the marking compositions 104a-d will emit a pattern of visible light as follows: BLUE-GREEN-ORANGE-GREEN. This particular emitted pattern of light may provide information that can authenticate the marked pharmaceutical pill 100. For example, this particular emitted pattern of light may be unique to the particular drug composition, thereby confirming the contents of the marked pharmaceutical pill 100. This particular pattern of marking compositions 104a-d may be unique to identify the product (e.g., the marked pharmaceutical pill 100) just as a fingerprint or handwriting can be used to identify an individual human.

Additionally, this particular emitted pattern of light may provide manufacturing information such as, for example, the date and location of manufacturing. A lookup table may be used to identify the information presented by the emitted light pattern. For example, the emitted color of the first marking composition 104a may correspond to the drug composition; the emitted color of the second marking composition 104b may correspond to the date of manufacture; the emitted color of the third marking composition 104c may correspond to the location of manufacture; and the emitted color of the fourth marking composition 104d may correspond to the manufacturing lot number. Further, in some embodiments, the one or more marking compositions 104a-d may have an after-glow or elongated phosphorescence. The particular decay in the glow after the radiated light is terminated may also be analyzed by an optical device and provide additional information about the marked pharmaceutical pill 100. In this way, for example, the combination of specific marking compositions and their emissions and the positional placement of the marking compositions (either 1-D or 2-D placement) can be used to convey a large amount of information regarding the product, its origins and manufacture.

In some other embodiments, at least one of the marking compositions 104a-d emits invisible light while at least one of the marking compositions 104a-d emits visible light. Thus, the particular emitted pattern provided by the marking compositions 104a-d may have a visible portion on the product and an invisible portion on the product.

In another embodiment, the marking composition 104 may comprise more than one energy converters at a same location on or within the marked pharmaceutical pill 100. In such embodiments, the marking composition 104 may emit a spectrum of wavelengths upon exposure to energy. The particular emitted spectrum provides information about the marked pharmaceutical pill 100. Such a particular spectrum based on multiple energy converters in a single marking composition 104 is more difficult for counterfeiters to copy; thus, a counterfeiter cannot counterfeit the marking composition 104 in an attempt to falsely authenticate a counterfeited item.

Additionally, in some embodiments, the marking composition 104 may act similarly to a QR Code, where the particular marking composition 104 corresponds to digital information like a website URL. The digital information may be further encrypted to provide another layer of authentication to the product. In a further embodiment, the marking composition 104 can convey the typical product and manufacturing authentication information, while being placed in a form of a QR Code which leads a user to the authentic website of the product manufacturer. With the marking composition 104 authentication, one can then be assured that the website information or additional product information embedded in the QR Code is also authentic.

In conventional bar coding operations, a scanner is used to essentially read a series of black and white lines with the density and spacings being indicative of a particular coded item. In this invention, these printed bar codes could make use of the nanocore emitters described above which offer the possibility of a multicolor emission from either singular or multiple infrared laser sources. Thus, the amount of information that can be encoded into a traditional bar code area may be greatly increased. For example, specific color categorization could introduce completely different encodings for what would normally be the same series of black and white lines. Further, combinations of differing color lines would permit further encoding of information even on top of the existing bar code lines which could be read by existing black and white imagers, adding information that would be indicative of the classes of product, class of distributers, class of manufacturers, classes of retailers, etc., in the product distribution chain. In this way, bar codes applied at the manufacture or food packager could be used for example in food product tracking safety and monitoring.

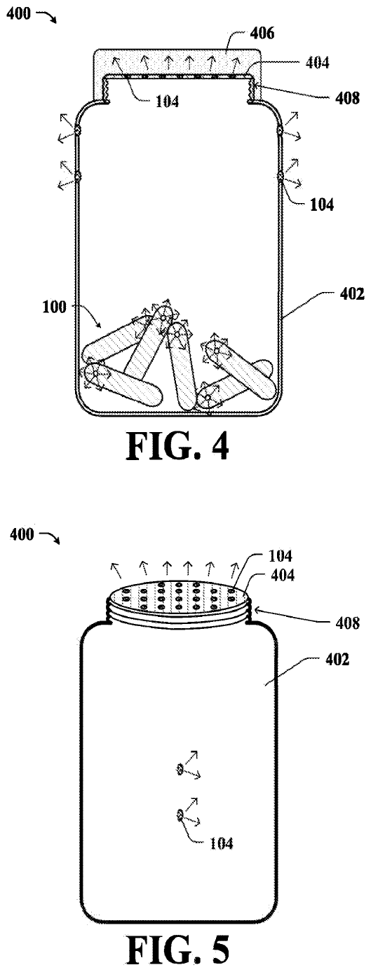

In a further embodiment, the marking composition 104 may be used to mark the packaging for the drug, including, but not limited to, bottles (glass, plastic, or other material), septa or stoppers used in containers, seals on containers, shrink wrap on packaging, boxes, and other containers used for pharmaceutical drug forms. For example, FIG. 4 illustrates a cross-sectional view of a pill bottle apparatus 400 comprising marking compositions 104. The pill bottle apparatus 400 comprises a housing 402 that forms the bottle shape, a cap 406 that attaches to a neck portion 408 of the housing 402, and a sealing structure 404 at the neck portion 408. In some embodiments, the housing 402 and cap 406 surround and contain the marked pharmaceutical pills 100.

Further, in some embodiments, the housing 402 may comprise one or more of the marking compositions 104. The marking compositions 104 may be applied to the housing 402 after manufacturing of the housing 402 through, for example, a deposition process, an ink-printing process, or application of an adhesive label containing the marking compositions 104. In other embodiments, the marking compositions 104 may be added to the raw material batch to form the housing 402 such that the marking compositions 104 are fully integrated with the housing 402. For example, if the housing 402 is formed via injection or blow molding, the marking compositions 104 may be added to the solid plastic or molten plastic prior to molding the housing 402. Similarly, in some embodiments, the marking compositions 104 may be formed on or within the cap 406 of the pill bottle apparatus 400. In some embodiments, the marking compositions 104 are arranged on the outer surfaces of the housing 402 and/or the cap 406 such that the packaging can be authenticated without disassembling the pill bottle apparatus 400. When the marking compositions 104 are arranged on the outer surfaces of the housing 402 and/or the cap 406, the marking compositions 104 will not come into contact with the marked pharmaceutical pills 100 and thus, there are no biocompatibility requirements. In other embodiments, the marking compositions 104 may be arranged on interior surfaces of the housing 402 and/or the cap 406. When the marking compositions 104 are arranged on the interior surfaces of the housing 402 and/or the cap 406, the marking compositions 104 will come into contact with the marked pharmaceutical pills 100 and thus, must be biocompatible.

As shown more clearly in the perspective view of FIG. 5, the pill bottle apparatus 400 further comprises the sealing structure 404 configured to seal the housing 402 at the neck portion 408. In some embodiments, the sealing structure 404 may comprise foil, paper, or some other material that protects the marked pharmaceutical pills 100 prior to consumption. In some embodiments, the sealing structure 404 may comprise an adhesive backing to seal to the neck portion 408 of the housing 402. In some embodiments, the sealing structure 404 may further extend between inner sidewalls of the cap 406 and outer sidewalls of the neck portion 408 such that the sealing structure 404 is contacted by threads of the cap 406 and of the neck portion 408. In some embodiments, the sealing structure 404 also comprises one or more marking compositions 104 on the upper surface such that the marking compositions 104 on the sealing structure 404 can be analyzed by removing the cap 406 but prior to breaking the seal between the sealing structure 404 and the housing 402. In FIG. 5, the sealing structure 404 comprises an array of marking compositions 104, for example. The array of marking compositions 104 on the sealing structure 404 may comprise a variety of energy converters to emit particular wavelengths in a particular pattern to convey particular information upon exposure to radiation. Further, as seen in FIG. 5, the housing 402 may be marked with marking compositions 104 that can be analyzed from the outer surface of the housing 402 without breaking the seal between the sealing structure 404 and the housing 402.

It will be appreciated that one or more of the components illustrated in FIG. 4 and FIG. 5 may comprise the marking compositions 104 to authenticate the origin of the pill bottle apparatus 400 and/or the pharmaceutical drug composition contained therein. In other words, the pill bottle apparatus 400 may have marking compositions 104 present on the housing 402, the sealing structure 404, and/or the cap 406. The pill bottle apparatus 400 may also contain marked pharmaceutical pills 100. Thus, the presence of marking compositions 104 on multiple parts of the pill bottle apparatus 400 and/or its contents allow a manufacturer, a distributor, and/or the consumer to authenticate the marked pharmaceutical pills 100 prior to consumption.

### Packaging Security/Anticounterfeiting

It will be appreciated that the same concepts of marking the pill bottle apparatus 400 and its contents (e.g., the marked pharmaceutical pills 100) with the marking compositions 104 as discussed with respect to FIG. 4 and FIG. 5 may apply to other products and packaging apparatuses. For example, in a further embodiment of the present invention, the marking compositions 104 containing the one or more energy converters can be used to externally mark any desired packaging, including, but not limited to, drug packaging, food packaging, medical devices such as syringes or IV bags, or any product package such as shrink wrap, crates, or boxes. In these embodiments, the marking compositions 104 can be placed on any desired surface, including, but not limited to, external packaging surfaces, seals, shrink wrap, crating, shipping containers (such as on oceangoing vessels), etc. In these embodiments, unless the package itself will come into contact with a food or drug substance, no biocompatibility requirements are present.

As a further example, in a hospital setting, IV bags comprising the marking compositions 104 may be analyzed by some portable scanning device and the drug delivered through the IV bags could be automatically entered into a patient's record. In some such embodiments, the portable scanning device may comprise an optical system configured to emit radiation towards the marking compositions 104 and process the emitted wavelengths from the marking compositions 104. In some embodiments, the optical system may include a spectrometer to receive the emitted wavelengths. In other embodiments, the optical system may include a CCD camera. The portable scanning device may send the emitted wavelength data to a processing unit that uses a lookup table to interpret the emitted wavelengths from the marking compositions 104. The processing unit may then record the desired information from the lookup table such as, for example, the drug within the IV bag.

For example, in some embodiments, the processing unit may be arranged within a computer; the portable scanning device may wirelessly send the emitted wavelength data to the processing unit of the computer; and the computer may store the IV bag drug information in the patient's records. In some other embodiments, the portable scanning device may comprise the processing unit; the processing unit may wirelessly send the drug information to the computer; and the computer may store the IV bag drug information in the patient's records. In some other embodiments, the marking compositions 104 may be arranged on a patient's ID wristband, and the portable scanner device may also be used to quickly confirm the patient's identity prior to administering any drugs or care to the patient.

### Packaging Security for Luxury and Consumer Goods

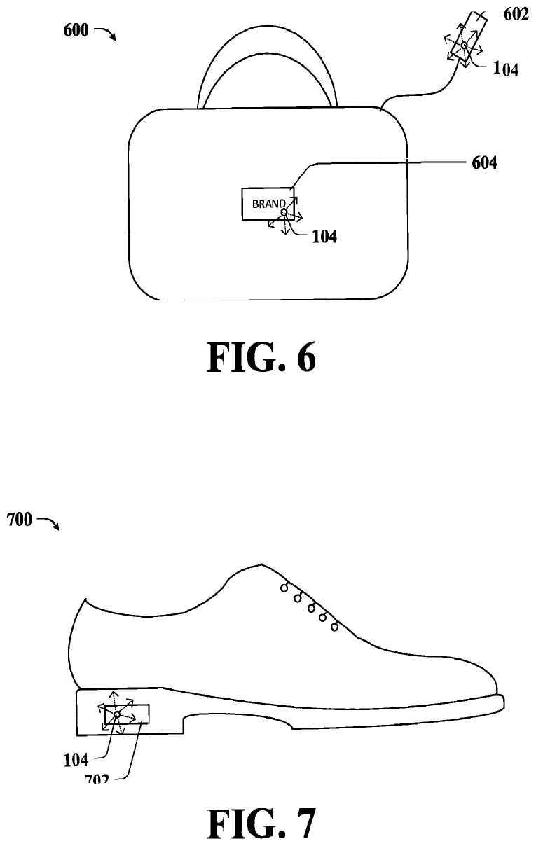

Referring to FIG. 6, the marking composition 104 can also be used to authenticate luxury and consumer goods such as a handbag 600, which are often subject to counterfeiting. It will be appreciated that more than one marking composition 104 may be marked on the handbag 600 to form a pattern such as the pattern described in FIG. 2 or to form a wavelength spectrum. In some embodiments, one or more marking compositions 104 may be temporarily attached to the handbag 600 via a tag apparatus 602. A customer may verify the authenticity of the handbag 600 upon receiving the handbag 600 by shining a UV light, for example, on the tag apparatus 602 and reading the emitted colors from the marking composition 104 on the tag apparatus 602. The customer may then compare the pattern of emitted colors from the marking composition 104 on the tag apparatus 602 with a pattern listed on the manufacturer's website to authenticate the handbag 600.

In other applications, the retailer, for example, may have a scanning device that is configured to shine a light at the marking composition 104 on the tag apparatus 602, receive the emitted light from the marking composition 104, compare the received light pattern with a known pattern, and deliver an “authenticated” message to the retailer if the received light pattern matches the known pattern. The “authenticated” message from the scanning device may be a sound, a light, digital text, or some other signal emitted from the scanning device. This authentication process may additionally be carried out by a distributor, manufacturer, reseller, or the like.

In some embodiments, the color of the marking composition 104 can be interpreted by the human eye. In other embodiments, the emitted wavelength by the marking composition is not visible light (e.g., is UV, VIS, NIR light) or the specific wavelength spectrum of the color emitted by the marking composition 104 cannot be distinguished by the human eye. In such other embodiments, a spectrometer or other detector is used to collect the emitted wavelength data.

Further, in some embodiments, one or more marking compositions 104 may be integrated within the handbag 600 such that it is more permanently attached to the handbag 600 compared to the tag apparatus 602. Therefore, the handbag 600 may be authenticated via the marking composition 104 throughout its lifetime. For example, as shown in FIG. 6, the marking composition 104 may be integrated in a portion of the handbag 600 that displays the brand name 604 of the handbag 600. In other embodiments, the marking composition 104 may be integrated into any other portion of the handbag 600 such as the handle, the interior of the body, the exterior of the body, or the like. Retailers, manufacturers, distributors, and customers may authenticate the handbag 600 by exposing the marking composition 104 to light and analyzing the emitted light as described previously. Because the marking composition 104 is integrated within the handbag 600, consumers and retailers may authenticate the handbag 600 at second-hand stores or on websites. This further prevents counterfeiting throughout the lifetime of the handbag 600.

Referring to FIG. 7, the marking compositions 104 can also be used to authenticate a shoe 700, which are often subject to counterfeiting. In some embodiments, one or more marking compositions 104 may be arranged on a label 702 which is fixed to some location on the shoe 700. In other embodiments, the marking composition 104 may be more integrated within the shoe 700 and located in a discrete location. The authenticity of the shoe 700 may be verified using the same or similar methods as described above with the handbag 600 in FIG. 6. Other luxury or consumer products can be similarly marked to authenticate them and to prevent counterfeiting.

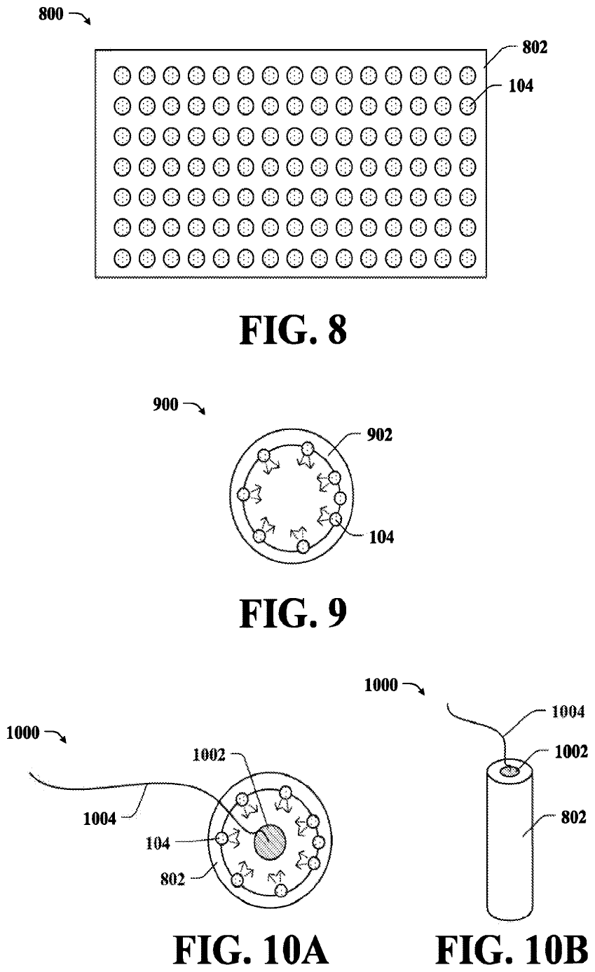

Referring now to FIGS. 8, 9, 10A, and 10B, various examples of labels that comprise the marking composition 104 are presented. FIG. 8 illustrates a label 800 comprising a large array of marking compositions 104 on a substrate 802. The substrate 802 may comprise paper, foil, cloth, or some other material. The location and the energy converter of each marking composition 104 corresponds to a piece of information. The label 800 in FIG. 8 is planar-like, which can be affixed to any article without taking up a lot of space. In some embodiments, the substrate 802 comprises an adhesive on a front or back surface to fix the substrate 802 to an article.

FIG. 9 illustrates a top view of the label 800 arranged in a cylinder form. In some embodiments, this cylinder form can be more rigid than the planar-like form illustrated in FIG. 8. In some embodiments, the cylinder form may be removed from the article that it authenticates for reading. Because the cylinder is more rigid, it can be removed and re-inserted to the article multiple times for authentication without damage to the label 800.

FIGS. 10A and 10B illustrate the label 800 arranged in the cylindrical form and also attached to a support tag 1002 and an attachment structure 1004. For example, in some embodiments, the cylindrical label comprising the marking compositions 104 is fixed to the support tag 1002, and the support tag 1002 is fixed to an article via the attachment structure 1004. In some embodiments, the attachment structure 1004 may be a textile string, a piece of plastic, a metal wire, or some other suitable material.

In some other embodiments, the marking composition 104 may comprise a gaseous form of one or more energy converters that are contained in a rigid capsule or container. These gas-filled capsules respond to applied microwave or RF fields by generating a light emitting plasma. The rigid capsule comprises a material that is resistant to damage by the applied microwaves or RF fields and also by the emitted plasma. The wavelength spectrum associated with the emitted plasma may be analyzed using one of the aforementioned methods to collect information stored in the marking composition 104. The gas-filled capsules comprising the marking composition 104 may be embedded in various products to provide marking compositions 104 on the product for the storage of information and authentication. For example, a gas-filled capsule comprising the marking composition 104 may be sewn into the body or handle of the handbag 604 in FIG. 6 such that the handbag 604 can be authenticated by this marking composition 104.

### Packaging Security and Identification of Shipping Container Contents

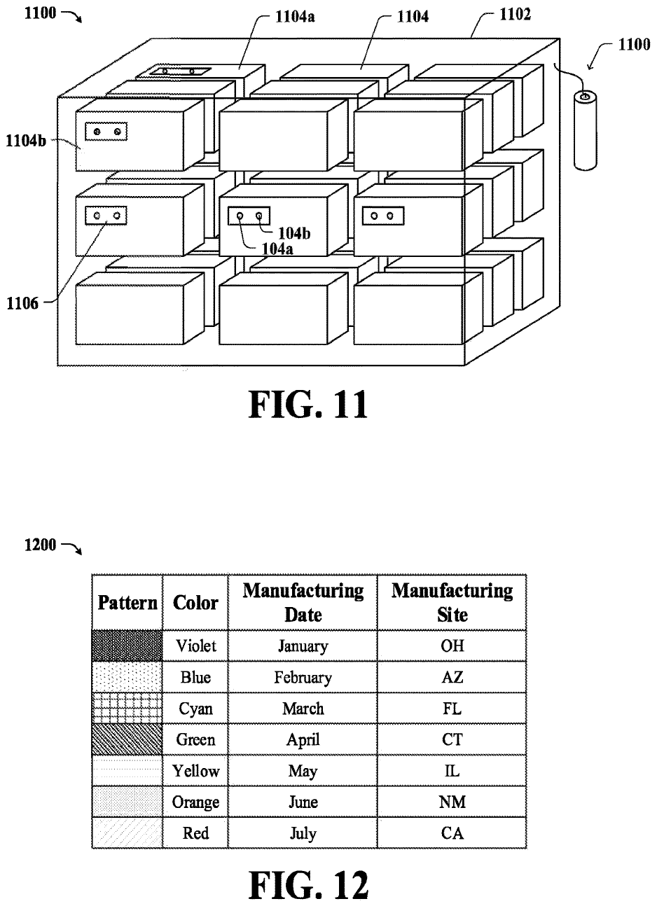

FIG. 11 illustrates yet another application of using marking compositions 104 to identify products. In FIG. 11, a shipping container 1100 comprising multiple packages 1104 is illustrated. One or more marking compositions 104 may be fixed to each package 1104 to provide information about the packages 1104. The marking compositions 104 on each package 1104 may emit wavelengths upon exposure to external energy such that a 3-D array of information can be analyzed, wherein the each position in the 3-D array of information corresponds to each package 1104. In some embodiments, the shipping container 1100 may comprise a label 800 externally that comprises information about its contents. In some embodiments, the marking compositions 104 are arranged on top surfaces, side surfaces, or bottom surfaces of the packages 1104. The marking compositions 104 may be fixed to each package 1104 via a tag, an adhesive label, or the like. In some implementations, the label 800 may a tag, an adhesive label, or the like. In some embodiments, the marking compositions 104 may emit wavelengths upon exposure to radiation without opening the shipping container 1100. Thus, information about the contents of the shipping container 110 can be quickly read without opening the shipping container 1100 and sorting through the various packages 1104 arranged therein. One or more devices may be used to emit the radiation toward the shipping container 1100 and process the information provided by the emitted wavelengths from the marking compositions 104. The radiation may include, for example, deeply penetrating energy such as X-rays, RF, or microwaves such that the marking compositions 104 on each package 1104 may be activated to emit wavelengths without opening the shipping container 1100.

Referring additionally to the lookup table 1200 in FIG. 12, in some embodiments, each package 1104 in the shipping container may have a first marking composition 104a arranged at a first position on the package 1104 and a second marking composition 104b arranged at a second position on the package 1104. The first marking composition 104a and the second marking composition 104b each correspond to a specific piece of information. For example, in the lookup table 1200, the first marking composition 104a may emit a color that corresponds to a manufacturing date. For example, if the first marking composition 104a emits a blue color, the package 1104 comprises products produced in February. The second marking composition 104b may emit a color that corresponds to a manufacturing site. For example, if the second marking composition 104b emits a yellow color, the package 1104 comprises products produced in Illinois. The packages 1104 may comprise additional marking compositions 104 corresponding to different pieces information such as position in the shipping container 1100, contents of the package 1104, and the like. It will be appreciated that the marking compositions 104 may emit invisible light such as UV or IR, and the lookup table 1200 may be based on the wavelength of the emitted UV or IR instead of on an emitted color.

### Credit Cards and Card Skimmers

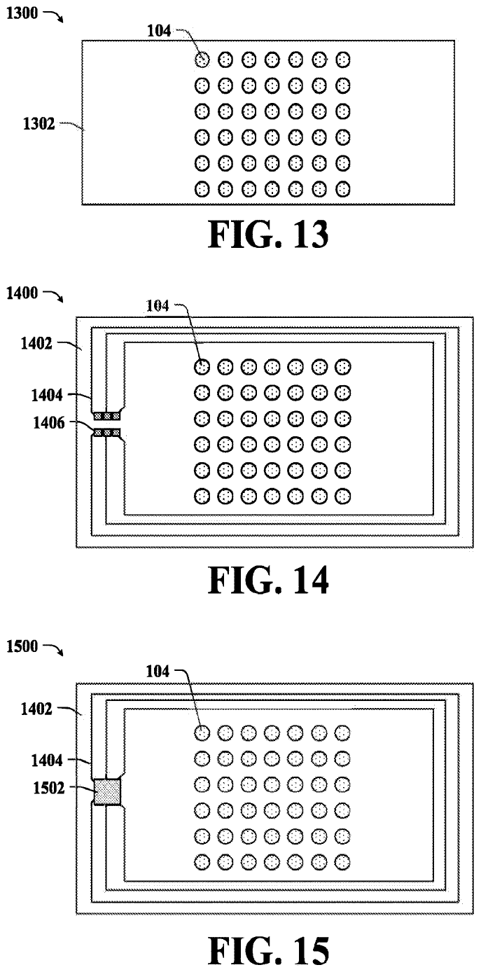

Referring now to FIGS. 13, 14, and 15, the marking compositions 104 may be applied to a credit card 1302 as another form of authentication for credit cards. For example, as shown in FIG. 13, one or more marking compositions 104 may be arranged on a credit card 1302. The marking compositions 104 may be read by a credit card reader and authenticated prior to processing the credit card information for a purchase. These marking compositions 104 may be more difficult to read and copy by a credit card skimmer device, thereby providing a more secure credit card 1302. The marking compositions 104 may be integrated within the magnetic strip on the credit card 1302 or may be on a unique location on the credit card 1302 separate from the magnetic strip. As shown in FIG. 14, the credit card 1302 may additionally comprise circuitry 1404 and antennae 1406. Thus, the credit card 1302 may comprise multiple layers of authentication and information via marking compositions 104, circuitry 1404, and antennae 1406 to add extra security to the credit card 1302. As shown in FIG. 15, the circuitry 1404 on the credit card 1302 may comprise an RFID chip in addition to the marking compositions 104. It will be appreciated that this circuitry 1404, antennae 1406, and/or RFID chip 1502 may be applied to any article or device in addition to the marking compositions 104 to provide multiple layers of protection to prevent counterfeiting.

### Other Applications

It will be appreciated that the marking compositions 104 as described in this application may also be applied to other products to authenticate the products and/or provide information about the products. Such other products may include, for example, currency, alcohol, tobacco, firearms, commodities (e.g., oil/gas tag and trace), military explosives, documents (e.g., certified documents), financial instruments (e.g., bonds, checks), other controlled substances, or the like.

### Method of Applying Marking Composition to Product

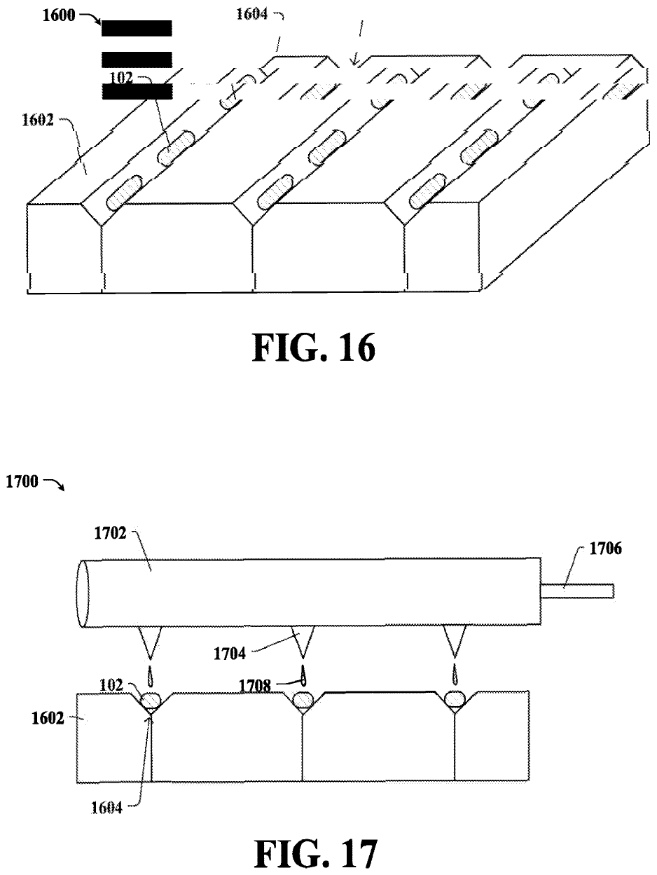

FIGS. 16, 17, 18, and 19 illustrate a method of marking pharmaceutical pills 102 with marking compositions 104 for authentication. The method in FIGS. 16, 17, 18, and 19 describes the marking of the pharmaceutical pills 100 after the pharmaceutical pills 100 have been produced. Thus, the marking compositions 104 are arranged on the external surface of the pharmaceutical pills 100 from this exemplary method. It will be appreciated that method illustrated and described in FIGS. 16-19 may be modified to mark other articles with marking compositions 104 such as, for example, handbags, shoes, clothing, labels, shipping containers, credit cards, or some other article requiring labeling and/or authentication.

FIG. 16 illustrates a sorting apparatus 1602 comprising grooved channels 1604. The pharmaceutical pills 100 may be arranged with the grooved channels 1604 from a vibratory bowl feeder, for example. The pharmaceutical pills 100 are aligned in the grooved channels 1604 and ready for marking with the marking compositions 104.

FIG. 17 illustrates a cross-sectional view 1700 of the sorting apparatus 1602 with a dispensing apparatus 1702 arranged over the sorting apparatus 1602. The dispensing apparatus 1702 may comprise an input 1706 that receives the marking composition 104. The dispensing apparatus 1702 comprises outputs 1704 that are directly arranged over each grooved channel 1604. The outputs 1704 are configured to dispense the marking composition 104 in a liquid form onto each pharmaceutical pill 100 in the grooved channels 1604. It will be appreciated that the process described in FIGS. 16 and 17 may be an automated process controlled by various computer devices.

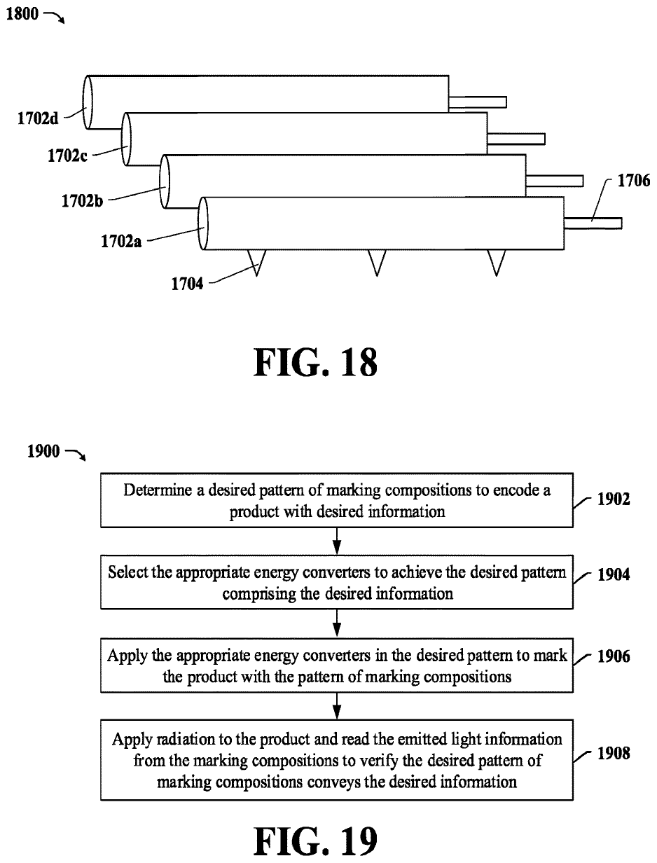

Referring additionally to FIG. 18, in some embodiments, multiple marking compositions 104 may be arranged on each pharmaceutical pill 100 like what is illustrated in FIG. 2. In some such embodiments, multiple dispensing apparatuses 1702 may be arranged over the grooved channels 1604, wherein each dispensing apparatus 1702 comprises a different energy converter for each marking composition 104. For example, as shown in FIG. 18, a first dispensing apparatus 1702a may comprise a first energy converter composition to form a first marking composition (e.g., 104a of FIG. 2) on the pharmaceutical pill 100; a second dispensing apparatus 1702b may comprise a second energy converter composition to form a second marking composition (e.g., 104b of FIG. 2) on the pharmaceutical pill 100; a third dispensing apparatus 1702c may comprise a third energy converter composition to form a third marking composition (e.g., 104c of FIG. 2) on the pharmaceutical pill 100; and a fourth dispensing apparatus 1702d may comprise a fourth energy converter composition to form a fourth marking composition (e.g., 104d of FIG. 2) on the pharmaceutical pill 100.

In some embodiments, the marking compositions 104 comprise the one or more energy converters and a carrier. The carrier may be a liquid, solvent, gel, or other medium for delivery of the energy converter to the desired location on the article (e.g., the pill body 102). For example, the one or more energy converters may dissolve into the carrier such that the carrier is a solvent, and the energy converters are a solute. In other embodiments, the one or more energy converters may not dissolve into the carrier and instead, the carrier may be a liquid medium mixed with the one or more energy converters in particulate form. In some embodiments, when the energy converters are integrated into a solvent, and the solvent is configured to evaporate during the marking process, thereby leaving behind the energy converter to form the marking composition 104.

In some embodiments, the carrier may be an ink-like composition. The energy converters may be integrated into the ink-like composition and the dispensing apparatus 1702 may apply the ink-like composition to the pharmaceutical pills 100 in a process similar to a printer. Thus, in some embodiments, the energy converters can be added to the ink for any printing machine to authenticate a product. For example, energy converters can be integrated into the ink for a shipping label such that the ink on the shipping label is marked with the marking composition 104.

FIG. 19 illustrates a flow chart 1900 of some embodiments of a method of marking an article with the marking compositions 104.

At step 1902, a desired pattern of marking compositions to encode a product with desired information may be determined.

At step 1904, the appropriate energy converters may be selected to achieve the desired pattern corresponding to the desired information.

At step 1906, the appropriate energy converters are applied to the product in the desired pattern to mark the product with the pattern of marking compositions.

At step 1908, radiation is applied to the product and emitted light information from the marking compositions is read to verify that the desired pattern of marking compositions conveys the desired information.

### Types of Energy Converters

The energy converters used in the present invention to form the marking compositions 104 can be any material that absorbs an applied radiation and emits a defined emission wavelength or wavelength spectrum. The energy converters preferably emit wavelengths or wavelength spectra in the UV, visible/color, and/or IR wavelengths. The applied energy can range from IR up through x-rays, depending on the energy converter used and the end use chosen.

In various embodiments of the invention, energy converters can be used with or without the energy augmentation structures described in U.S. Published Application 2022/0275914, incorporated herein by reference in its entirety. In some embodiments, the converters are for up conversion of light e.g., from the IR regime into visible electromagnetic radiation and for down conversion of light e.g., from the UV range into visible electromagnetic radiation. The invention in various embodiments up converts energy, preferably light in the visible spectrum. The invention encompasses a variety of applications where the up and down conversion materials with or without the energy augmentation structures are included to enhance electromagnetic energy emission, preferably light or photon emission. When an energy augmentation structure is present, it may be separate from or connected to the energy converter. In certain embodiments, the energy converter can have the energy augmentation structure formed on its surface through chemical vapor deposition (“CVD”) or physical vapor deposition (“PVD”) processes or other nanoscale “printing” methods. Such embodiments may be particularly useful in methods for treating human or animal patients, in which having such energy augmentation structures “imprinted” on a surface of the energy converter can guarantee proximity between the energy augmentation structure and the energy converter to maximize the interaction with the energy being applied. Alternatively, the energy augmentation structure can be formed on a surface of an inert non-energy converting particle, formed, for example, from silica or formed from a non-energy converting particle coated with a biologically and/or chemically inert coating (such as, for example, diamond, diamond-like carbon, or similar inert materials). Such an energy augmentation structure can then be used with a similarly coated energy converter for uses requiring biologically or chemically inert conditions.

Suitable energy modulation agents or energy converters (the two terms are used interchangeably herein) of the invention include, but are not limited to, a biocompatible fluorescing metal nanoparticle, fluorescing dye molecule, gold nanoparticle, a water soluble quantum dot encapsulated by polyamidoamine dendrimers, a luciferase (bioluminescence), a biocompatible phosphorescent molecule, a combined electromagnetic energy harvester molecule, and a lanthanide chelate capable of intense luminescence.

Alternatively, the energy modulation agent or energy converter can emit energy in a form suitable for absorption at a target site or receptor. For example, the initiation energy source may be acoustic energy and one energy converter may be capable of receiving acoustic energy and emitting photonic energy (e.g. sonoluminescent molecules) to be received by another energy converter that is capable of receiving photonic energy. Other examples include energy converters that receive energy at x-ray wavelength and emit energy at UV wavelength, preferably at UV-A wavelength. A plurality of such energy converters may be used to form a cascade to transfer energy from initiation energy source via a series of energy converters.

Resonance Energy Transfer (RET) is an energy transfer mechanism between two molecules having overlapping emission and absorption bands. Electromagnetic emitters are capable of converting an arriving wavelength to a longer wavelength. For example, UV-B energy absorbed by a first molecule may be transferred by a dipole-dipole interaction to a UV-A-emitting molecule in close proximity to the UV-B-absorbing molecule. Alternatively, a material absorbing a shorter wavelength may be chosen to provide RET to a non-emitting molecule that has an overlapping absorption band with the transferring molecule's emission band. Alternatively, phosphorescence, chemiluminescence, or bioluminescence may be used to transfer energy to a target site or a receptor such as a photoactivatable agent.

In a further embodiment, a biocompatible emitting source, such as a fluorescing metal nanoparticle or fluorescing dye molecule, is selected as an energy converter that emits in the UV-A band. In another embodiment, an energy converter comprising a UV-A emitting source can be a gold nanoparticle comprising for example a cluster of 5 gold atoms.

In another embodiment, an energy converter comprising a UV- or light-emitting luciferase is selected as the emitting source. A luciferase may be combined with ATP or another molecule, which may then be oxygenated with additional molecules to stimulate light emission at a desired wavelength. Alternatively, a phosphorescent emitting source may be used as the energy converter. Phosphorescent materials may have longer relaxation times than fluorescent materials, because relaxation of a triplet state is subject to forbidden energy state transitions, storing the energy in the excited triplet state with only a limited number of quantum mechanical energy transfer processes available for returning to the lower energy state. Energy emission is delayed or prolonged from a fraction of a second to several hours. Otherwise, the energy emitted during phosphorescent relaxation is not otherwise different than fluorescence, and the range of wavelengths may be selected by choosing a particular phosphor.

U.S. Pat. No. 9,232,618 (the entire contents of which are incorporated herein by reference) describes that in various embodiments, the energy modulation agents are gas containing up converter structures where energy from microwave radiation or radiofrequency radiation directly or indirectly generates emitted light in the infrared, visible, or ultraviolet range to produce physical and/or biological changes in the medium. Ammonia and argon gasses are also of special interest. Ammonia has been used to create MASERs due to its response to microwave energy. It absorbs microwave energy, and in various embodiments significant rotational energy can be pumped into ammonia molecules. Most gasses including argon can be ionized using microwave radiation and using a Tesla coil or a combination thereof. These two gases can be used as a base from which other gases can be added to produce specific UV or VIS or IR spectral emissions of interest.

In one embodiment, the energy converters of the invention can include persistent after-glow phosphor materials emitting light in the visible to near ultraviolet and ultraviolet range. In one embodiment, Eu-doped strontium aluminate is used as an energy converter in which deep UV light or x-ray or electron beans “charge” the photoluminescence such that these phosphors can be charged outside for example a patient and then injected into a target or diseased site where UV photons would be emitted. In another embodiment, gadolinium strontium magnesium aluminate is used as an energy converter in which deep UV light or x-ray or electron beams “charge” the photoluminescence. U.S. Pat. Appl. Publ. No. 20070221883 (the entire contents of which are incorporated herein by reference) describes specifically gadolinium-activated strontium magnesium aluminate having an excitation maximum at about 172 nm, and which emits in a narrow-band UV emission at about 310 nm. The '883 publication also describes other useful energy converters for this invention, making note of emission spectra between 300 nm and 320 nm for a Sr(Al,Mg)₁₂O₁₉:Gd phosphor and two 312 nm line emitting phosphors, YMgB₅O₁₀:Gd, Ce and YMgB₅O₁₀:Gd, Ce, Pr. WO2016200349 (the entire contents of which are incorporated herein by reference) describes long lasting yellowish-green emitting phosphorescent pigments in the strontium aluminate (SrAl2O4) system, which could serve as energy converters in the present invention. WO 2016200348 (the entire contents of which are incorporated herein by reference) describes long lasting bluish-green emitting phosphorescent pigments in the strontium aluminate (Sr4Al14O25) system, which could serve as energy converters in the present invention. Xiong et al in “Recent advances in ultraviolet persistent phosphors,” Optical Materials X 2 (2019) (the entire contents of which are incorporated herein by reference) describes a number of ultraviolet persistent phosphors that could as energy converters in the present invention. The table below provides a listing of such persistent phosphors:

| | | |
|---|---|---|
| SrO:Pb²⁺ | 390 | >1 h |
| CaAl₂O₄:Ce³⁺ Tb³⁺ | 400 | >10 h |
| CaAl₂O₄:Ce³⁺ Tb³⁺ | 413 | >10 h |
| Sr₂Al₂SiO₇:Ce³⁺ | 400 | several minutes |
| SrZrO₃ | 395 | <1000 s |
| BaZrO₃:Mg²⁺ | 400 | >2400 s |
| SrZrO₃:Pr³⁺ | 356 | |
| CdSiO₃:Bi³⁺ | 360 | |
| CdSiO₃:Bi³⁺ Dy³⁺ | 360 | |
| CdSiO₃: Bi³⁺ Gd³⁺ | 344 | >6 h |
| Sr₂MgGe₂O₇:Pb²⁺ | 370 | >12 h |
| NaLuGeO₄:Bi³⁺ Eu³⁺ | 400 | >63 h |
| CaZnGe₂O₆: Bi³⁺ | 300-700 | >12 h |
| Ca₂NaYF₆:Pr³⁺ | 250 | >2 h |

In one embodiment, the phosphor described by Xiong et al as CaAl₂O₄:Ce³⁺ having an emission peak of 400 nm and a persistent time of more than 10 h could be used.

In another embodiment, a combined electromagnetic energy harvester molecule is designed, such as the combined light harvester disclosed in J. Am. Chem. Soc. 2005, 127, 9760-9768, the entire contents of which are hereby incorporated by reference. By combining a group of fluorescent molecules in a molecular structure, a resonance energy transfer cascade may be used to harvest a wide band of electromagnetic radiation resulting in emission of a narrow band of fluorescent energy. In another embodiment, a Stokes shift of an emitting source or a series of emitting sources arranged in a cascade is selected to convert a shorter wavelength energy, such as X-rays, to a longer wavelength fluorescence emission such an optical or UV-A.

In one embodiment, a lanthanide chelate capable of intense luminescence is used as an energy converter. In another embodiment, a biocompatible, endogenous fluorophore emitter is selected as an energy converter.

In one embodiment, the energy converters of the invention can include visible and UV-light emitting bioluminescent materials. In one embodiment, bioluminescent materials such as coelenterate-type luciferin analogues could be used including amide monoanion known to emit at 480 nm and oxyluciferin known to emit at 395 nm.

Among various materials, luminescent nanoparticles have attracted increasing technological and industrial interest. In the context of the invention, nanoparticle refers to a particle having a size less than one micron. While the description of the invention describes specific examples using nanoparticles, the invention in many embodiments is not limited to particles having a size less than one micron. However, in many of the embodiments, the size range of less than one micron, and especially less than 100 nm produces properties of special interest such as for example emission lifetime luminescence quenching, luminescent quantum efficiency, and concentration quenching and such as for example diffusion, penetration, and dispersion into mediums where larger size particles would not migrate.

This invention in various embodiments can use a wide variety of down conversion materials (or mixtures of down conversion materials) with or without the energy augmentation structures to enhance light or photon emission. These down conversion materials can include quantum dots, semiconductor materials, alloys of semiconductor materials, scintillation and phosphor materials, materials that exhibit X-ray excited luminescence (XEOL), organic solids, metal complexes, inorganic solids, crystals, rare earth materials (lanthanides), polymers, scintillators, phosphor materials, etc., and materials that exhibit excitonic properties. Accordingly, the down conversion materials to enhance light or photon emission can convert energy from one of ultraviolet light, x-rays, and high energy particles to visible light. The down conversion materials to enhance light or photon emission can convert energy from higher energy visible light to lower energy visible light.

In one embodiment of the invention, a quantum dot mixture with or without the energy augmentation structures can be used for the multiple nanoparticles. Quantum dots are in general nanometer size particles whose energy states in the material of the quantum dot are dependent on the size of the quantum dot. For example, quantum dots are known to be semiconductors whose conducting characteristics are closely related to the size and shape of the individual crystal. Generally, the smaller the size of the crystal, the larger the band gap, the greater the difference in energy between the highest valence band and the lowest conduction band becomes. Therefore, more energy is needed to excite the dot, and concurrently, more energy is released when the crystal returns to its resting state. In fluorescent dye applications, this equates to higher frequencies of light emitted after excitation of the dot as the crystal size grows smaller, resulting in a color shift from red to blue in the light emitted. Quantum dots represent one way to down convert ultraviolet light of the spectrum to a targeted wavelength or energy emission. Quantum dots represent one way to down convert blue light of the spectrum to a targeted wavelength or energy emission.

As described in U.S. Pat. No. 6,744,960 (the entire contents of which are incorporated by reference), different size quantum dots produce different color emissions. In that work and applicable to this invention, quantum dots can comprise various materials including semiconductors such as zinc selenide (ZnSe), cadmium selenide (CdSe), cadmium sulfide (CdS), indium arsenide (InAs), and indium phosphide (InP). Another material that may suitably be employed is titanium dioxide (TiO₂). The size of the particle, i.e., the quantum dot, may range from about 2 to 10 nm. Since the size of these particles is so small, quantum physics governs many of the electrical and optical properties of the quantum dot. One such result of the application of quantum mechanics to the quantum dot is that quantum dots absorb a broad spectrum of optical wavelengths and re-emit radiation having a wavelength that is longer than the wavelength of the absorbed light. The wavelength of the emitted light is governed by the size of the quantum dot. For example, CdSe quantum dots 5.0 nm in diameter emit radiation having a narrow spectral distribution centered about 625 nm while quantum dots including CdSe 2.2 nm in size emit light having a center wavelength of about 500 nm. Semiconductor quantum dots comprising CdSe, InP, and InAs, can emit radiation having center wavelengths in the range between 400 nm to about 1.5 μm. Titanium dioxide TiO₂ also emits in this range. The linewidth of the emission, i.e., full-width half-maximum (FWHM), for these semiconductor materials may range from about 20 to 30 nm. To produce this narrowband emission, quantum dots simply need to absorb light having wavelengths shorter than the wavelength of the light emitted by the dots. For example, for 5.0 nm diameter CdSe quantum dots light having wavelengths shorter than about 625 nm is absorbed to produce emission at about 625 nm while for 2.2 nm quantum dots comprising CdSe light having wavelengths smaller than about 500 nm is absorbed and re-emitted at about 500 nm. In practice, however, the excitation or pump radiation is at least about 50 nanometers shorter than the emitted radiation.

Specifically, in one embodiment of the invention, a quantum dot mixture (QDM) coating can be deposited using CVD and or sol-gel techniques using standard precipitation techniques. The QDM coating can be made of a silicate structure that does not diminish UV output. Within the silicate family, silica (SiO₂) is suitable since it maximizes UV transmission through the coating. The coating can further include a second layer of a biocompatible glass. Such bio-compatible glass and glass ceramic compositions can contain calcium, a lanthanide or yttrium, silicon, phosphorus and oxygen. Other biocompatible materials and techniques are described in the following patents which are incorporated herein in their entirety: U.S. Pat. Nos. 5,034,353; 4,786,617; 3,981,736; 3,922,155; 4,120,730; and U.S. Pat. Appl. Nos. 2008/0057096; 2006/0275368; and 2010/0023101.

Further, the down conversion materials for the invention described here can be coated with insulator materials such as for example silica which will reduce the likelihood of any chemical interaction between the luminescent particles and the medium the particles are included therein. These and the other conversion materials described here can be used with or without energy augmentation structures. For biocompatible applications of inorganic nanoparticles, one of the major limiting factors is their toxicity. Generally speaking, all semiconductor nanoparticles are more or less toxic. For biocompatible applications, nanoparticles with toxicity as low as possible are desirable or else the nanoparticles have to remain separated from the medium. Pure TiO₂, ZnO, and Fe₂O₃ are biocompatible. CdTe and CdSe are toxic, while ZnS, CaS, BaS, SrS and Y₂O₃ are less toxic. In addition, the toxicity of nanoparticles can result from their inorganic stabilizers, such as TGA, or from dopants such as Eu²⁺, Cr³⁺ or Nd³⁺. Other suitable down conversion materials which would seem the most biocompatible are zinc sulfide, ZnS:Mn²⁺, ferric oxide, titanium oxide, zinc oxide, zinc oxide containing small amounts of Al₂O₃, and AgI nanoclusters encapsulated in zeolite. For non-medical applications, where toxicity may not be as critical a concern, the following materials (as well as those listed elsewhere) are considered suitable: lanthanum and gadolinium oxyhalides activated with thulium; Er³⁺ doped BaTiO₃ nanoparticles, Yb³⁺ doped CsMnCl₃ and RbMnCl₃, BaFBr:Eu²⁺ nanoparticles, Cesium Iodine, Bismuth Germanate, Cadmium Tungstate, and CsBr doped with divalent Eu.

In various embodiments of the invention, the following luminescent polymers with or without energy augmentation structures are also suitable as conversion materials: poly(phenylene ethynylene), poly(phenylene vinylene), poly(p-phenylene), poly(thiophene), poly(pyridyl vinylene), poly(pyrrole), poly(acetylene), poly(vinyl carbazole), poly(fluorenes), and the like, as well as copolymers and/or derivatives thereof.

In various embodiments of the invention, the following materials, with or without energy augmentation structures, can be used similar to that detailed in U.S. Pat. No. 7,090,355, the entire contents of which are incorporated herein by reference. For down-conversion, the following materials can be used. Inorganic or ceramic phosphors or nano-particles, including but not limited to metal oxides, metal halides, metal chalcogenides (e.g. metal sulfides), or their hybrids, such as metal oxo-halides, metal oxo-chalcogenides. Laser dyes and small organic molecules, and fluorescent organic polymers. Semiconductor nano-particles, such as II-VI or III-V compound semiconductors, e.g. fluorescent quantum dots. Organometallic molecules including at least a metal center such as rare earth elements (e.g. Eu, Tb, Ce, Er, Tm, Pr, Ho) and transitional metal elements such as Cr, Mn, Zn, Ir, Ru, V, and main group elements such as B, Al, Ga, etc. The metal elements are chemically bonded to organic groups to prevent the quenching of the fluorescence from the hosts or solvents. Phosphors can be used including the Garnet series of phosphors: (YₘA₁₋ₘ)₃(AlₙB₁₋ₙ)₅O₁₂, doped with Ce; where 0≤m, n≤1, where A includes other rare earth elements, B includes B, Ga. In addition, phosphors containing metal silicates, metal borates, metal phosphates, and metal aluminates hosts can be used. In addition, nano-particulates phosphors containing common rare earth elements (e.g. Eu, Tb, Ce, Dy, Er, Pr, and Tm) and transitional or main group elements (e.g. Mn, Cr, Ti, Ag, Cu, Zn, Bi, Pb, Sn, and Tl) as the fluorescent activators, can be used. Materials such as Ca, Zn, Cd in tungstates, metal vanadates, ZnO, etc. can be used.

The commercial laser dye materials obtained from several laser dye vendors, including Lambda Physik, and Exciton, etc. can also be used with or without energy augmentation structures. A partial list of the preferred laser dye classes includes: Pyrromethene, Coumarin, Rhodamine, Fluorescein, other aromatic hydrocarbons and their derivatives, etc. In addition, there are many polymers containing unsaturated carbon-carbon bonds, which also serve as fluorescent materials and find many optical and fluorescent applications. For example, MEH-PPV, PPV, etc. have been used in opto-electronic devices, such as polymer light emitting diodes (PLED). Such fluorescent polymers can be used directly as the fluorescent layer of the transparent 2-D display screen with and without energy augmentation structures.

As noted above, semiconductor nanoparticles (e.g., quantum dots) can be used with or without energy augmentation structures. The terms “semiconductor nanoparticles,” in the art refers to an inorganic crystallite between 1 nm and 1000 nm in diameter, preferably between 2 nm to 50 nm. A semiconductor nano-particle is capable of emitting electromagnetic radiation upon excitation (i.e., the semiconductor nano-particle is luminescent). The nanoparticle can be either a homogeneous nano-crystal, or comprises of multiple shells. For example, the nanoparticle can include a “core” of one or more first semiconductor materials, and may be surrounded by a “shell” of a second semiconductor material. The core and/or the shell can be a semiconductor material including, but not limited to, those of the group II-VI (ZnS, ZnSe, ZnTe, CdS, CdSe, CdTe, HgS, HgSe, HgTe, MgS, MgSe, MgTe, CaS, CaSe, CaTe, SrS, SrSe, SrTe, BaS, BaSe, BaTe, and the like) and III-V (GaN, GaP, GaAs, GaSb, InN, InP, InAs, InSb, and the like) and IV (Ge, Si, and the like) materials, and an alloy or a mixture thereof.

Fluorescent organometallic molecules containing rare earth or transitional element cations can be used for down conversion materials, with or without energy augmentation structures. Such molecules include a metal center of rare earth elements including Eu, Tb, Er, Tm, Ce protected with organic chelating groups. The metal center may also include transitional elements such as Zn, Mn, Cr, Ir, etc. and main group elements such as B, Al, Ga. Such organometallic molecules can readily dissolve in liquid or transparent solid host media. Some examples of such fluorescent organometallic molecules include: 1. Tris(dibenzoylmethane)mono(phenanthroline)europium(III); 2. Tris(8-hydroxyquinoline)erbium; 3. Tris(1-phenyl-3-methyl-4-(2,2-dimethylpropan-1-oyl)pyrazolin-5-one)terbium(III); 4. Bis(2-methyl-8-hydroxyquinolato)zinc; 5. Diphenylborane-8-hydroxyquinolate.

Specific examples of down-conversion materials for red emission include those discussed above and europium complexes such as those described in JP Laid-open Patent Publication (Kokai) No. 2003-26969, constructed such that B-diketone ligand is coordinated to europium forming an europium complex capable of emitting red fluorescence. Other specific examples of the rare earth element complexes include complexes include lanthanum (Ln), europium (Eu), terbium (Tb), and gadolinium (Gd) and combinations thereof. An europium (Eu) complex is capable of emitting red fluorescence when irradiated with ultraviolet rays having a wavelength ranging from 365 nm to 410 nm. Terbium (Tb) is capable of emitting green fluorescence when irradiated with ultraviolet rays having a wavelength of 365 nm.

In other down-conversion embodiments, the down conversion materials which emit red light may include europium, light emitting particles which emit green light may include Terbium, and light emitting particles which emit blue or yellow light may include cerium (and/or thulium). In up-conversion embodiments, up conversion materials which emit red light may include praseodymium, light emitting particles which emit green light may include erbium, and light emitting particles which emit blue light may include thulium. In embodiments, the conversion materials can be light emitting particles made of fluorescent molecules that emit different colors (e.g. red, green, and blue), or different wavelengths or energies of light. In embodiments, the conversion materials can be light emitting particles made of pure organic or organo-metallic dyes with or without energy augmentation structures.

In addition to the combinations of rare earth complexes, such as a combination of a europium complex and a terbium complex, it is also possible employ a combination of a europium complex and a green-emitting fluorescent substance which is not a complex, or a combination of a terbium complex and a red-emitting fluorescent substance which is not a complex.

Other down converter materials (which can be used with or without energy augmentation structures) include for example ZnS, PbS, SbS₃, MoS₂, PbTe, PbSe, BeO, MgO. Li₂CO₃, Ca(OH)₂, MoO₃, SiO₂, Al₂O₃, TeO₂, SnO₂, KBr, KCl, and NaCl. These materials can include dopants to tailor the emission properties, as noted above. Examples of doped (or alloyed) glass systems suitable for the include Y₂O₃:Gd, Y₂O₃:Dy, Y₂O₃:Tb, Y₂O₃:Ho, Y₂O₃:Er, Y₂O₃:Tm, Gd₂O₃:Eu, Y₂O₂S:Pr, Y₂O₂S:Sm, Y₂O₂S:Eu, Y₂O₂S:Tb, Y₂O₂S:Ho, Y₂O₂S:Er, Y₂O₂S:Dy, Y₂O₂S:Tm, ZnS:Ag:Cl (blue), ZnS:Cu:Al (green), Y₂O₂S:Eu (red), Y₂O₃:Eu (red), YVO₄:Eu (red), and Zn₂SiO₄:Mn (green).

With regard more specifically to down converter materials suitable for the invention, U.S. Pat. No. 4,705,952 (the contents of which are hereby incorporated herein by reference) describes an infrared-triggered phosphor that stores energy in the form of visible light of a first wavelength and released energy in the form of visible light of a second wavelength when triggered by infrared light. The phosphors in U.S. Pat. No. 4,705,952 were compositions of alkaline earth metal sulfides, rare earth dopants, and fusible salts. The phosphors in U.S. Pat. No. 4,705,952 were more specifically phosphors made from strontium sulfide, barium sulfide and mixtures thereof; including a dopant from the rare earth series and europium oxide, and mixtures thereof; and including a fusible salt of fluorides, chlorides, bromides, and iodides of lithium, sodium, potassium, cesium, magnesium, calcium, strontium, and barium, and mixtures thereof. The materials described in U.S. Pat. No. 4,705,952 are useful in various embodiments of the invention with or without energy augmentation structures. In one example, the infrared-triggered phosphors would be used in conjunction with the folded resonators, and the receipt of a microwave or IR signal would locally heat and trigger emission. (This application would be particularly well suited for color enhancement and/or security applications.)

In other embodiments of the invention, the down converter materials (or mixtures of down converters materials (which can be used with or without energy augmentation structures) can include Y₂O₃:Li. Sun et al “Luminescent properties of Li+ doped nanosized Y₂O₃:Eu,” Solid State Comm. 119 (2001) 393-396 (the entire contents of which are incorporated herein by reference) describe such materials. Hou et al “Luminescent properties nano-sized Y₂O₃:Eu fabricated by co-precipitation method,” Journal of Alloys and Compounds, vol. 494, issue 1-2, 2 Apr. 2010, pages 382-385 (the entire contents of which are incorporated herein by reference) describe that nano-sized yttria (Y₂O₃) powders have been successfully synthesized by a co-precipitation method. The powders were well crystallized, and the grains were almost spherical with good dispersibility. The quenching concentration of Eu³⁺ ions is 9 mol % which is much higher than micro-scaled powders. The incorporation of Li+ ions greatly improved the luminescence intensity. The highest emission intensity was observed with 4 mol % Li+ doped Y₂O₃:Eu powder ((Y_{0.87}Eu_{0.09}Li_{0.04})₂O₃) and the fluorescence intensity was increased by as much as 79%. Yi et al “Improved cathodoluminescent characteristics of Y₂O₃:Eu³⁺ thin films by Li-doping,” Appl. Phys. A 87, 667-671 (2007) (the entire contents of which are incorporated herein by reference) describe cathodoluminescent spectra for both Y₂O₃:Eu³⁺ and Li-doped Y₂O₃:Eu³⁺ films and methods for making these materials.

Specific downconverting materials may also include at least one or more of Y₂O₃, Y₂O₃:Gd, Y₂O₂S, NaYF₄, NaYbF₄, YAG, YAP, Nd₂O₃, LaF₃, LaCl₃, La₂O₃, TiO₂, LuPO₄, YVO₄, YbF₃, YF₃, Na-doped YbF₃, ZnS, ZnSe, MgS, CaS, Zn₂SiO₄:Mn, LaOBr:Tm and alkali lead silicate including compositions of SiO₂, B₂O₃, Na₂O, K₂O, PbO, MgO, or Ag, and combinations or alloys or layers thereof. Furthermore, the down-converting materials can be sulfur containing phosphors, which can help for example in the rubber vulcanization or other photoactivated processes. An example of such a sulfur containing phosphor is: (Sr,Ca) Ga₂S₄. Other examples wherein said phosphor particles comprise a thiogallate host material selected from the group consisting of SrGa₂S₄, CaGa₂S₄ BaGa₂S₄, MgGa₂S₄ and solid solutions thereof. The particle size of such phosphor can be controlled from 25 nm to 300 microns in size as described in U.S. Pat. No. 6,153,123A. The downconverting materials can include a dopant including at least one of Er, Eu, Yb, Tm, Nd, Mn, Sb, Tb, Ce, Y, U, Pr, La, Gd and other rare-earth species or a combination thereof. The dopant can be included at a concentration of 0.01%-50% by mol concentration. At times it is preferable to have a combination of dopants rather than one dopant such is the case for a Mn and Sb in silicate matrices.

The invention in other embodiments can use a wide variety of up conversion materials (or mixtures of up converters), with or without the energy augmentation structures to enhance a particular wavelength or energy of light emitted from a material or surface. These up conversion materials can include similar materials as discussed above with regard to down conversion but typically included doped or impurity states in a host crystal that provide a mechanism for up conversion pumping. Accordingly, the up conversion materials to enhance wavelength or energy emission can convert energy from one of near infrared, infrared, and microwave irradiation. Certain of the upconversion materials can convert energy from lower energy visible light to higher energy visible light.

In one example, a nanoparticle of a lanthanide doped oxide can be excited with near infrared light such as laser light at 980 nm and 808 nm to produce visible light in different parts of the red, green, blue spectrum (different wavelengths or energies) depending on the dopant trivalent rare earth ion(s) chosen, their concentration, and the host lattice.

The lanthanide doped oxides suitable for this invention differ from more traditional multi-photon up conversion processes where the absorption of, for example, two photons is needed in a simultaneous event to promote an electron from a valence state directly into an upper level conduction band state where relaxation across the band gap of the material produces fluorescence. Here, the co-doping produces states in the band gap of the NaYF₄ such that the Yb³⁺ ion has an energy state at ²F_{5/2} pumpable by a single photon event and from which other single photon absorption events can populate even higher states. Once in this exited state, transitions to higher energy radiative states are possible, from which light emission will be at a higher energy than that of the incident light pumping the ²F_{5/2} energy state. In other words, the energy state at ²F_{5/2} of the Yb³⁺ ion is the state that absorbs 980 nm light permitting a population build up serving as the basis for the transitions to the higher energy states such as the ⁴F_{7/2} energy state. Here, transitions from the ⁴F_{7/2} energy state produce visible emissions.

U.S. Pat. No. 7,008,559 (the entire contents of which are incorporated herein by reference) describes the upconversion performance of ZnS where excitation at 767 nm produces emission in the visible range. The materials described in U.S. Pat. No. 7,008,559 (including the ZnS as well as Er³⁺ doped BaTiO₃ nanoparticles and Yb³⁺ doped CsMnCl₃) are suitable in various embodiments of the invention, with or without the energy augmentation structures.

Further, materials specified for up conversion materials in the invention (with or without energy augmentation) include CdTe, CdSe, ZnO, CdS, Y₂O₃, MgS, CaS, SrS and BaS. Such up conversion materials may be any semiconductor and more specifically, but not by way of limitation, sulfide, telluride, selenide, and oxide semiconductors and their nanoparticles, such as Zn₁₋ₓMnₓS_{y}, Zn₁₋ₓMnₓSe_{y}, Zn₁₋ₓMnₓTe_{y}, Cd₁₋ₓMnS_{y}, Cd₁₋ₓMnₓSe_{y}, Cd₁₋ₓMnₓTe_{y}, Pb₁₋ₓMnₓS_{y}, Pb₁₋ₓMnₓSe_{y}, Pb₁₋ₓMnₓTe_{y}, Mg₁₋ₓMnS_{y}, Ca₁₋ₓMnₓS_{y}, Ba₁₋ₓMnₓS_{y} and Sr₁₋ₓ, etc. (wherein, 0<x≤1, and 0<y≤1). Complex compounds of the above-described semiconductors are also contemplated for use in the invention—e.g. (M_{1-z}N_{z})₁₋ₓMnₓA_{1-y}B_{y} (M=Zn, Cd, Pb, Ca, Ba, Sr, Mg; N=Zn, Cd, Pb, Ca, Ba, Sr, Mg; A=S, Se, Te, O; B=S, Se, Te, O; 0<x≤1, 0<y≤1, 0<z≤1). Two examples of such complex compounds are Zn_{0.4}Cd_{0.4}Mn_{0.2}S and Zn_{0.9}Mn_{0.1}S_{0.8}Se_{0.2}. Additional conversion materials include insulating and nonconducting materials such as BaF₂, BaFBr, and BaTiO₃, to name but a few exemplary compounds. Transition and rare earth ion co-doped semiconductors suitable for the invention include sulfide, telluride, selenide and oxide semiconductors and their nanoparticles, such as ZnS; Mn; Er; ZnSe; Mn, Er; MgS; Mn, Er; CaS; Mn, Er; ZnS; Mn, Yb; ZnSe; Mn, Yb; MgS; Mn, Yb; CaS; Mn, Yb etc., and their complex compounds: (M_{1-z}N_{z})₁₋ₓ(Mn_{q}R_{1-q})ₓA_{1-y}B_{y} (M=Zn, Cd, Pb, Ca, Ba, Sr, Mg; N=Zn, Cd, Pb, Ca, Ba, Sr, Mg; A=S, Se, Te, O; B=S, . . . 0<z≤1, o<q≤1).

Some nanoparticles such as ZnS:Tb³⁺, Er³⁺; ZnS:Tb³⁺; Y₂O₃:Tb³⁺; Y₂O₃:Tb³⁺, Er³⁺; ZnS:Mn²⁺; ZnS:Mn,Er³⁺ are known in the art to function for both down-conversion luminescence and upconversion luminescence and would be suitable for the invention with or without energy augmentation structures. In up-conversion embodiments, light emitting particles which emit red light may include praseodymium, light emitting particles which emit green light may include erbium, and light emitting particles which emit blue light may include thulium.

In general, the upconversion process generally requires one of more rare-earth dopants, such as Er, Eu, Yb, Tm, Nd, Tb, Ce, Y, U, Pr, La, Gd and other rare-earth species or a combination thereof, doped into a dielectric crystal (of any size >0.1 nm), including at least one of Y₂O₃, Y₂O₂S, NaYF₄, NaYbF₄, YAG, YAP, Nd₂O₃, LaF₃, LaCl₃, La₂O₃, TiO₂, LuPO₄, YVO₄, YbF₃, YF₃, Na-doped YbF₃, or SiO₂, where incident radiation is at longer wavelength than emissive radiation from the crystal. The wavelength emitted in based entirely on the dopant ion(s) chosen and their associated and relative concentration in the host crystal. For the example of upconversion in a Y₂O₃ host crystal, to achieve a blue emission (~450-480 nm) one could synthesize [Y₂O₃; Yb (3%), Tm (0.2%)], where the Yb and Tm are the percentages doped in the crystal relative to the Y atoms being 100%. Likewise, typical green upconversion materials are [Y₂O₃; Yb (5%), Ho (1%)] and [Y₂O₃; Yb (2%), Er (1%)], and typical red upconversion materials are [Y₂O₃; Yb (10%), Er (1%)] and [Y₂O₃; Yb (5%), Eu (1%)]. The concentrations of dopants relative to each other and the crystal matrix must be tuned for every combination, and there are multiple ways to achieve multiple wavelength or energy emissions from even the same dopants.

Up-conversion of red light with a wavelength of about 650 nm in Tm³⁺ doped flourozirconate glasses can be used in the invention to produce blue light. In this system, the blue light consists of two emission bands; one at 450 nm which is ascribed to the 1D2→3H4 transition, the others at 475 nm is ascribed to the 1G4→3H6 transition. The emission intensities of both bands have been observed by others to vary quadratically with the excitation power. For glasses with a Tm³⁺ concentration of 0.2 mol % and greater, cross-relaxation processes occur which decrease the up-conversion efficiency.

The emission of visible light upon excitation in the near-infrared (NIR) has been observed in optically clear colloidal solutions of LuPO₄: Yb³⁺, Tm³⁺, and YbPO₄:Er³⁺ nanocrystals in chloroform. Excitation at 975 nm has been shown by others to produce visible emission in the blue, green, or red spectral regions.

Tellurium and germanium oxides (tellurites and germanates) are also suitable upconverters. These glasses can be doped with Tm, Yb, Ho, Er, Pr, for example.

Yb³⁺ doped BaZrO₃ is also suitable for upconversion. Er³⁺ and/or Tm³⁺ doping are also suitable for tailoring the emission wavelengths.

In another embodiment, Nd³⁺:Cs₂NaGdCl₆ and Nd³⁺, Yb³⁺:Cs₂NaGdCl₆ polycrystalline powder samples prepared by Morss method have been reported to be up converters and are suitable for the present invention. These materials, under 785 nm irradiation, have shown upconversion emissions near 538 nm (Green), 603 nm (Orange), and 675 nm (Red) were observed and assigned to 4G7/2→4I9/2, (4G7/2→4I11/2; 4G5/2→4I9/2), and (4G7/2→4I13/2; 4G5/2→4I11/2), respectively.

In another embodiment, Nd³⁺ and Ho³⁺ co-doped-based ZrF₄ fluoride glasses under 800 nm excitation have been reported to be up converters and are suitable for the present invention. Among the up-conversion luminescences for the ZrF₄ fluoride glasses, the green emission was seen to be extremely strong and the blue and red emission intensities were very weak.

In another embodiment, Tm³⁺/Yb³⁺-codoped TeO₂—Ga₂O₃—R₂O (R=Li, Na, K) glasses have been reported to be up converters and are suitable for the present invention. These materials, under excitation at 977 nm, showed intense blue upconversion emission centered at 476 nm along with a weak red emission at 650 nm.

In another embodiment, metal-to-ligand charge transfer (MLCT) transition in [Ru(dmb)₃]²⁺ (dmb=4,4′-dimethyl-2,2′-bipyridine) in the presence of anthracene or 9,10-diphenylanthracene have been reported to be up converters and are suitable for the present invention. Upconverted singlet fluorescence resulting from triplet-triplet annihilation at low excitation power has been reported. In particular 9,10-diphenylanthracene (DPA) (substituted for anthracene) showed higher efficiencies for upconversion. In these experiments, workers with this material system assumed that DPA's increased singlet fluorescence quantum yield (=0.95) relative to anthracene (=0.27)7. This work lead to an approximate 24.4±6.1 enhancement of green-to-blue light upconversion permitting direct visualization of the process at low excitation power, for example by a commercial green laser pointer (λₑₓ=532 nm, <5 mW peak power).

In certain embodiments, further energy converters include, but are not limited to, (not ranked by order of preference or utility):
CaF₂, ZnF₂, KMgF₃, ZnGa₂O₄, ZnAl₂O₄, Zn₂SiO₄, Zn₂GeO₄, Ca₅(PO₄)₃F, Sr₅(PO₄)₃F, CaSiO₃, MgSiO₃, ZnS, MgGa₂O₄, LaAl₁₁O₁₈, Zn₂SiO₄, Ca₅(PO₄)₃F, Mg₄Ta₂O₉, CaF₂, LiAl₅O₈, LiAlO₂, CaPO₃, AlF₃, and LuPO₄:Pr³⁺. Examples further include the alkali earth chalcogenide phosphors which are in turn exemplified by the following non-inclusive list: MgS:Eu³⁺, CaS:Mn²⁺, CaS:Cu, CaS:Sb, CaS:Ce³⁺, CaS:Eu²⁺, CaS:Eu²⁺Ce³⁺, CaS:Sm³⁺, CaS:Pb²⁺, CaO:Mn²⁺, CaO:Pb²⁺.

Further examples include the ZnS type phosphors that encompass various derivatives: ZnS:Cu,Al(Cl), ZnS:Cl(Al), ZnS:Cu,I(Cl), ZnS:Cu, ZnS:Cu,In.

Also included are the compound IIIb-Vb phosphors which include the group IIIb and Vb elements of the periodic table. These semiconductors include BN, BP, BSb, AlN, AlP, AlAs, AlSb, GaN, GaP, GaAs, GaSb, InN, InP, InAs, InSb and these materials may include donors and acceptors that work together to induce light emission diodes. These donors include, but are not limited to, Li, Sn, Si, Li, Te, Se, S, O and acceptors include, but are not limited to, C, Be, Mg, Zn, Cd, Si, Ge. Further included are the major GaP light emitting diodes which include, but are not limited to, GaP:Zn,O, GaP:NN, Gap:N and GaP, which emit colors Red, Yellow, Green and Pure Green respectively.

The materials can further include such materials as GaAs with compositional variation of the following sort: In_{1-y}(Ga₁₋ₓAlₓ)_{y}P.

Also included is silicon carbide SiC, which has commercial relevancy as a luminescent platform in blue light emitting diodes. These include the polytypes 3C—SiC, 6H—SiC, 4H—SiC with donors such as N and Al and acceptors such as Ga and B.

Further examples include multiband luminescent materials include, but not limited to, the following compositions (Sr, Ca, Ba)₅(PO₄)₃Cl:Eu²⁺, BaMg₂Al₁₆O₂₇:Eu²⁺, CeMgAl₁₁O₁₉:Ce³⁺:Tb³⁺, LaPO₄:Ce³⁺:Tb³⁺, GdMgB₅O₁₀:Ce₃:Tb³⁺, Y₂O₃:Eu³⁺, (Ba,Ca,Mg)₅(PO₄)₃Cl:Eu²⁺, 2SrO_{0.84}P2O50.16B2O3:Eu²⁺, Sr₄Al₁₄O₂₅:Eu²⁺.

Materials typically used for fluorescent high pressure mercury discharge lamps are also included. These can be excited with X-Ray and are exemplified by way of family designation as follows: Phosphates (Sr, M)(PO₄)₂:Sn²⁺, Mg or Zn activator, Germanate 4MgO·GeO₂:Mn⁴⁺, 4(MgO, MgF₂)GeO₂:Mn⁴⁺, Yttrate Y₂O₃:Eu³⁺, Vanadate YVO₄:Eu³⁺, Y(P,V)O₄:Eu³⁺, Y(P,V)O₄:In⁺, Halo-Silicate Sr₂Si₃O₈₂SrCl₂:Eu²⁺, Aluminate (Ba,Mg)₂Al₁₆O₂₄:Eu²⁺, (Ba, Mg)₂Al₁₆O₂₄:Eu²⁺,Mn²⁺, Y₂O₃Al₂O₃:Tb³⁺.

Another grouping by host compound includes chemical compositions in the halophosphates phosphors, phosphate phosphors, silicate phosphors, aluminate phosphors, borate phosphors, tungstate phosphors, and other phosphors. The halophosphates include, but are not limited to: 3Ca₃(PO₄)₂·Ca(F,Cl)₂:Sb³⁺, 3Ca₃(PO₄)₂·Ca(F,Cl)₂:Sb³⁺/Mn²⁺, Sr₁₀(PO₄)₆Cl₂:Eu²⁺, (Sr,Ca)₁₀(PO₄)₆Cl₂:Eu²⁺, (Sr,Ca)₁₀(PO₄)₆·nB₂O₃:Eu³⁺, (Sr, Ca,Mg)₁₀(PO₄)₆Cl₂:Eu²⁺. The phosphate phosphors include, but are not limited to: Sr₂P₂O₇:Sn²⁺, (Sr,Mg)₃(PO₄)₂:Sn²⁺, Ca₃(PO₄)₂·Sn²⁺, Ca₃(PO₄)₂:Tl⁺, (Ca,Zn)₃(PO₄)₂:Tl⁺, Sr₂P₂O₇:Eu²⁺, SrMgP₂O₇:Eu²⁺, Sr₃(PO₄)₂:Eu²⁺, LaPO₄:Ce³⁺, Tb³⁺, La₂O₃·0.2SiO₂·0.9P₂O₅:Ce³⁺·Tb³⁺, BaO·TiO₂·P₂O₅. The silicate phosphors Zn₂SiO₄:Mn²⁺, CaSiO₃:Pb²⁺Mn²⁺, (Ba, Sr, Mg)·3Si₂O₇:Pb²⁺, BaSi₂O₅:Pb²⁺, Sr₂Si₃O₈·2SrCl₂:Eu²⁺, Ba₃MgSi₂O₈:Eu²⁺, (Sr,Ba)Al₂Si₂O₈:Eu²⁺.

The aluminate phosphors include, but are not limited to: LiAlO₂:Fe³⁺, BaAl₈O₁₃:Eu²⁺, BaMg₂Al₁₆O₂₇:Eu²⁺, BaMg₂Al₁₆O₂₇:Eu²⁺/Mn²⁺, Sr₄Al₁₄O₂₅:Eu²⁺, CeMgAl₁₁O₁₉:Ce³⁺/Tb³⁺.

The borate phosphors include: Cd₂B₂O₅:Mn²⁺, SrB₄O₇F:Eu²⁺, GdMgB₅O₁₀:Ce³⁺/Tb³⁺, GdMgB₅O₁₀:Ce³⁺/Mn³⁺, GdMgB₅O₁₀:Ce³⁺/Tb³⁺/Mn²⁺.

The tungstate phosphors include, but are not limited to: CaWO₄, (Ca,Pb)WO₄, MgWO₄. Other phosphors Y₂O₃:Eu³⁺, Y(V,P)O₄:Eu²⁺, YVO₄:Dy³⁺, MgGa₂O₄:Mn²⁺, 6MgO·As₂O₅:Mn²⁺, 3.5MgO·0.5MgF₂·GeO₂:Mn⁴⁺.

The activators to the various doped phosphors include, but are not limited to: Tl⁺, Pb²⁺, Ce³⁺, Eu²⁺, WO₄²⁻, Sn²⁺, Sb³⁺, Mn²⁺, Tb³⁺, Eu³⁺, Mn⁴⁺, Fe³⁺. The luminescence center Tl⁺ is used with a chemical composition such as: (Ca,Zn)₃(PO₄)₂:Tl⁺, Ca₃(PO₄)₂:Tl⁺. The luminescence center Mn²⁺ is used with chemical compositions such as MgGa₂O₄:Mn²⁺, BaMg₂Al₁₆O₂₇:Eu²⁺/Mn²⁺, Zn₂SiO₄:Mn²⁺, 3Ca₃(PO₄)₂·Ca(F,Cl)₂:Sb²⁺/Mn²⁺, CaSiO₃:Pb²⁺/Mn²⁺, Cd₂B₂O₅:Mn²⁺, CdB₂O₅:Mn²⁺, GdMgB₅O₁₀:Ce³⁺/Mn²⁺, GdMgB₅O₁₀:Ce³⁺/Tb³⁺/Mn²⁺. The luminescence center Sn²⁺ is used with chemical compositions such as: Sr₂P₂O₇:Sn²⁺, (Sr,Mg)₃(PO₄)₂:Sn²⁺. The luminescence center Eu²⁺ is used with chemical compositions such as: SrB₄O₇F:Eu²⁺, (Sr,Ba)Al₂Si₂O₈:Eu²⁺, Sr₃(PO₄)₂:Eu²⁺, Sr₂P₂O₇:Eu²⁺, Ba₃MgSi₂O₈:Eu²⁺, Sr₁₀(PO₄)₆Cl₂:Eu²⁺, BaMg₂Al₁₆O₂₇:Eu²⁺/Mn²⁺, (Sr,Ca)₁₀(PO₄)₆Cl₂:Eu²⁺. The luminescence center Pb²⁺ is used with chemical compositions such as: (Ba,Mg,Zn)₃Si₂O₇:Pb²⁺, BaSi₂O₅:Pb²⁺, (Ba,Sr)₃Si₂O₇:Pb²⁺.

The luminescence center Sb²⁺ is used with chemical compositions such as: 3Ca₃(PO₄)₂·Ca(F,Cl)₂:Sb³⁺, 3Ca₃(PO₄)₂·Ca(F,Cl)₂:Sb³⁺/Mn²⁺.

The luminescence center Tb³⁺ is used with chemical compositions such as: CeMgAl₁₁O₁₉:Ce³⁺/Tb³⁺, LaPO₄:Ce³⁺/Tb³⁺, Y₂SiO₅:Ce³⁺/Tb³⁺, GdMgB₅O₁₀:Ce³⁺/Tb³⁺. The luminescence center Eu³⁺ is used with chemical compositions such as: Y₂O₃:Eu³⁺, Y(V,P)O₄:Eu³⁺. The luminescence center Dy³⁺ is used with chemical compositions such as: YVO₄:Dy³⁺. The luminescence center Fe³⁺ is used with chemical compositions such as: LiAlO₂:Fe³⁺. The luminescence center Mn⁴⁺ is used with chemical compositions such as: 6MgO·As₂O₅:Mn⁴⁺, 3.5MgO0.5MgF₂·GeO₂:Mn⁴⁺. The luminescence center Ce³⁺ is used with chemical compositions such as: Ca₂MgSi₂O₇:Ce³⁺ and Y₂SiO₅:Ce³⁺. The luminescence center WO₄²⁻ is used with chemical compositions such as: CaWO₄, (Ca,Pb)WO₄, MgWO₄. The luminescence center TiO₄⁴⁻ is used with chemical compositions such as: BaO·TiO₂·P₂O₅.

Additional phosphor chemistries of interest using X-Ray excitations include, but are not limited to, the k-edge of these phosphors. Low energy excitation can lead to intense luminescence in materials with low k-edge. Some of these chemistries and the corresponding k-edge are listed below:

| | |
|---|---|
| BaFCl:Eu²⁺ | 37.38 keV |
| BaSO₄:Eu²⁺ | 37.38 keV |
| CaWO₄ | 69.48 keV |
| Gd₂O₂S:Tb³⁺ | 50.22 keV |
| LaOBr:Tb³⁺ | 38.92 keV |
| LaOBr:Tm³⁺ | 38.92 keV |
| La₂O₂S:Tb³⁺ | 38.92 keV |
| Y₂O₂S:Tb³⁺ | 17.04 keV |
| YTaO₄ | 67.42 keV |
| YTaO₄:Nb | 67.42 keV |
| ZnS:Ag | 9.66 keV |
| (Zn,Cd)S:Ag | 9.66/26.7 keV |

These materials can be used alone or in combinations of two or more. A variety of compositions can be prepared to obtain the desired output wavelength or spectrum of wavelengths.

In the present invention, the phosphor selection could be chosen such that under x-ray or other high energy source irradiation, the light emitted from the phosphors could, for example, have exemplary characteristics including:

Emissions in 190-250 nm wavelength range;

Emissions in the 330-340 nm wavelength range.

Electroluminescent and phosphorescent materials (organic and inorganic): The present invention in various embodiments can utilize organic fluorescent molecules or inorganic particles capable or fluorescence and phosphorescence having crystalline, polycrystalline or amorphous micro-structures for the converters (optionally including the energy augmentation structures described above).

The list of inorganic molecules that can be used with or without energy augmentation structures for the electroluminescence and phosphorescent materials described below include but is not limited to the following inorganic electroluminescent phosphor materials:
SrS:Ce³⁺
CaGa₂S₄:Ce³⁺
SrS:Cu⁺
CaS:Pb²⁺
BaAl₂S₄:Eu²⁺
ZnS:Tb³⁺
ZnMgS:Mn²⁺
SrGa₂S₄:Eu²⁺
CaAl₂S₄:Eu²⁺
BaAl₂S₄:Eu²⁺
ZnS:Mn²⁺
MgGa₂O₄:Eu³⁺
(Ca, Sr)Y₂S₄:Eu²⁺
BaAl₂S₄:Eu²⁺

Organic molecules that can phosphoresce under the influence of an electric field are also of interest in the present application. The organic fluorescent compounds with high quantum yield include by way of illustration:
Naphthalene,
Pyrene,
Perylene,
Anthracene,
Phenanthrene,
p-Terphenyl,
p-Quartphenyl,
Trans-stilbene,
Tetraphenylbutadiene,
Distyrylbenzene,
2,5-Diphenyloxazole,
4-Methyl-7-diethylaminocoumarin,
2-Phenyl-5-(4-biphenyl)-1,3,4-oxadiazole,
3-Phenylcarbostyryl,
1,3,5-Triphenyl-2-pyrazoline,
1,8-Naphthoylene-1′, 2′-bezimidazole,
4-Amino-N-phenyl-naphthalimide.

The inorganic fluorescent and phosphorescent materials detailed here are numerous, and various examples are given by way of illustration rather than limitation and can be used with or without energy augmentation structures. Furthermore, these materials can be doped with specific ions (activators or a combination of activators) that occupy a site in the lattice structure in the case of crystalline or polycrystalline materials and could occupy a network forming site or a bridging and/or non-bridging site in amorphous materials. These compounds could include (not ranked by order of preference or utility) the following material examples:
CaF₂, ZnF₂, KMgF₃, ZnGa₂O₄, ZnAl₂O₄, Zn₂SiO₄, Zn₂GeO₄, Ca₅(PO₄)₃F, Sr₅(PO₄)₃F, CaSiO₃, MgSiO₃, ZnS, MgGa₂O₄, LaAl₁₁Oi₈, Zn₂SiO₄, Ca₅(PO₄)₃F, Mg₄Ta₂O₉, CaF₂, LiAl₅O₈, LiAlO₂, CaPO₃, AlF₃.

Further included are alkali earth chalcogenide phosphors which are in turn exemplified by the following non-inclusive list:

MgS:Eu³⁺, CaS:Mn²⁺, CaS:Cu, CaS:Sb, CaS:Ce³⁺, CaS:Eu²⁺, CaS:Eu²⁺Ce³⁺, CaS:Sm³⁺, CaS:Pb²⁺, CaO:Mn²⁺, CaO:Pb²⁺.

The examples include the ZnS type phosphors that encompass various derivatives:
ZnS:Cu,Al(Cl), ZnS:Cl(Al), ZnS:Cu,I(Cl), ZnS:Cu, ZnS:Cu,In.

Compound IIb-Vb phosphors which include the group IIIb and Vb elements of the periodic table are suitable for converter materials. These semiconductors include BN, BP, BSb, AlN, AlP, AlAs, AlSb, GaN, GaP, GaAs, GaSb, InN, InP, InAs, InSb and these materials have donors and acceptors that work in together to induce light emission diodes. The donors include Li, Sn, Si, Li, Te, Se, S, O, and acceptors include C, Be, Mg, Zn, Cd, Si, Ge. As an example, GaP light emitting diodes include GaP:Zn, O, GaP:NN, Gap:N and GaP which emit colors Red, Yellow, Green and Pure Green respectively.

The compounded materials further include such materials as GaAs with compositional variation of the following sort: In1-y(Ga1-xAlx)yP (provides a simple example).

Silicon Carbide SiC as a luminescent platform has commercial relevancy if the blue light emitting diodes. These include the polytypes 3C—SiC, 6H—SiC, 4H—SiC with donors such as N and Al and acceptors such as Ga and B.

Multiband luminescent materials suitable for converter materials include for example the following compositions:
(Sr, Ca, Ba)₅(PO₄)₃Cl:Eu²⁺, BaMg₂Al₁₆O₂₇:Eu²⁺, CeMgAl₁₁O₁₉:Ce³⁺:Tb³⁺, LaPO₄:Ce³⁺:Tb³⁺, GdMgB₅O₁₀:Ce³⁺:Tb³⁺, Y₂O₃:Eu³⁺, (Ba,Ca,Mg)₅(PO₄)₃Cl:Eu²⁺, 2SrO_{0.84}P₂O₅·0.16B₂O₃:Eu²⁺, Sr₄Al₁₄O₂₅:Eu²⁺.

Other materials suitable for converter materials include those materials used for fluorescent high pressure mercury discharge lamps can be excited with X-Ray and are exemplified by way of family designation as follows:
Phosphates (Sr, M)(PO₄)₂:Sn²⁺, Mg or Zn activator, Germanate 4MgO·GeO₂:Mn⁴⁺, 4(MgO, MgF₂)GeO₂:Mn⁴⁺, Yttrate Y₂O₃:Eu³⁺, Vanadate YVO₄:Eu³⁺, Y(P,V)O₄:Eu³⁺, Y(P,V)O₄:In⁺, Halo-Silicate Sr2Si3O₈·2SrCl₂:Eu²⁺, Aluminate (Ba,Mg)₂Al₁₆O₂₄:Eu²⁺, (Ba, Mg)₂Al₁₆O₂₄:Eu²⁺, Mn²⁺, Y₂O₃Al₂O₃:Tb³⁺.

Another grouping of materials suitable for converter materials by host compound include chemical compositions in the Halophosphates phosphors, Phosphate phosphors, Silicate phosphors, Aluminate phosphors, Borate phosphors, Tungstate phosphors, and other phosphors.

The halophosphates include by way of illustration:
3Ca₃(PO₄)₂·Ca(F,Cl)₂:Sb³⁺, 3Ca₃(PO₄)₂·Ca(F,Cl)₂:Sb³⁺/Mn²⁺, Sr₁₀(PO₄)₆Cl₂:Eu²⁺, (Sr,Ca)₁₀(PO₄)₆Cl₂:Eu²⁺, (Sr,Ca)₁₀(PO₄)₆·nB₂O₃:Eu³⁺, (Sr, Ca,Mg)₁₀(PO₄)₆Cl₂:Eu²⁺. The phosphate phosphors include by way of illustration Sr₂P₂O₇:Sn²⁺, (Sr,Mg)₃(PO₄)₂:Sn²⁺, Ca₃(PO₄)₂·Sn²⁺, Ca₃(PO₄)₂:Tl⁺, (Ca,Zn)₃(PO₄)₂:Tl⁺, Sr₂P₂O₇:Eu²⁺, SrMgP₂O₇:Eu²⁺, Sr₃(PO₄)₂:Eu²⁺, LaPO₄:Ce³⁺, Tb³⁺, La₂O₃·0.2SiO₂·0.9P₂O₅:Ce³⁺·Tb³⁺, BaO·TiO₂·P₂O₅. The silicate phosphors Zn₂SiO₄:Mn²⁺, CaSiO₃:Pb²⁺/Mn²⁺, (Ba, Sr, Mg)₃Si₂O₇:Pb²⁺, BaSi₂O₅:Pb²⁺, Sr₂Si₃O₈·2SrCl₂:Eu²⁺, Ba₃MgSi₂O₈:Eu²⁺, (Sr,Ba)Al₂Si₂O₈:Eu²⁺.

The aluminate phosphors include:
LiAlO₂:Fe³⁺, BaAl₈O₁₃:Eu²⁺, BaMg₂Al₁₆O₂₇:Eu²⁺, BaMg₂Al₁₆O₂₇:Eu²⁺/Mn²⁺, Sr₄Al₁₄O₂₅:Eu²⁺, CeMgAl₁₁O₁₉:Ce³⁺/Tb³⁺.

The borate phosphors include:
Cd₂B₂O₅:Mn²⁺, SrB₄O₇F:Eu²⁺, GdMgB₅O₁₀:Ce³⁺/Tb³⁺, GdMgB₅O₁₀:Ce³⁺/Mn³⁺, GdMgB₅O₁₀:Ce³⁺/Tb³⁺/Mn²⁺.

The tungstate phosphors include:
CaWO₄, (Ca,Pb)WO₄, MgWO₄. Other phosphors Y₂O₃:Eu³⁺, Y(V,P)O₄:Eu²⁺, YVO₄:Dy³⁺, MgGa₂O₄:Mn²⁺, 6MgO·As₂O₅:Mn²⁺, 3.5MgO·0.5MgF₂·GeO₂:Mn⁴⁺.

Activators of relevance to the various doped phosphors include the following list:
Tl⁺, Pb²⁺, Ce³⁺, Eu²⁺, WO₄²⁻, Sn²⁺, Sb³⁺, Mn²⁺, Tb³⁺, Eu³⁺, Mn⁴⁺, Fe³⁺.

In various embodiments, the luminescence center Tl⁺ can be used with a chemical composition such as:
(Ca,Zn)₃(PO₄)₂:Tl⁺, Ca₃(PO₄)₂:Tl⁺.

Similarly, the luminescence center Mn2+ can be used with chemical compositions such as
MgGa₂O₄:Mn²⁺, BaMg₂Al₁₆O₂₇:Eu²⁺/Mn²⁺, Zn₂SiO₄:Mn²⁺, 3Ca₃(PO₄)₂·Ca(F,Cl)₂:Sb²⁺/Mn²⁺, CaSiO₃:Pb²⁺/Mn²⁺, Cd₂B₂O₅:Mn²⁺, CdB₂O₅:Mn²⁺, GdMgB₅O₁₀:Ce³⁺/Mn²⁺, GdMgB₅O₁₀:Ce³⁺/Tb³⁺/Mn²⁺.

Further, the luminescence center Sn²⁺ can be used with chemical compositions such as:
Sr₂P₂O₇:Sn²⁺, (Sr,Mg)₃(PO₄)₂:Sn²⁺.

The luminescence center Eu²⁺ can also be used with chemical compositions such as:
SrB₄O₇F:Eu²⁺, (Sr,Ba)Al₂Si₂O₈:Eu²⁺, Sr₃(PO₄)₂:Eu²⁺, Sr₂P₂O₇:Eu²⁺, Ba₃MgSi₂O₈:Eu²⁺, Sr₁₀(PO₄)₆Cl₂:Eu²⁺, BaMg₂Al₁₆O₂₇:Eu²⁺/Mn²⁺, (Sr,Ca)₁₀(PO₄)₆Cl₂:Eu²⁺.

The luminescence center Pb²⁺ can be used with chemical compositions such as:
(Ba,Mg,Zn)₃Si₂O₇:Pb²⁺, BaSi₂O₅:Pb²⁺, (Ba,Sr)₃Si₂O₇:Pb²⁺.

The luminescence center Sb²⁺ can be used with chemical compositions such as:
3Ca₃(PO₄)₂·Ca(F,Cl)₂:Sb³⁺, 3Ca₃(PO₄)₂·Ca(F,Cl)₂:Sb³⁺/Mn²⁺.

The luminescence center Tb3+ can be used with chemical compositions such as:
CeMgAl₁₁O₁₉:Ce³⁺/Tb³⁺, LaPO₄:Ce³⁺/Tb³⁺, Y₂SiO₅:Ce³⁺/Tb³⁺, GdMgB₅O₁₀:Ce³⁺/Tb³⁺.

The luminescence center Eu³⁺ can be used with chemical compositions such as:
Y₂O₃:Eu³⁺, Y(V,P)O₄:Eu³⁺.

The luminescence center Dy³⁺ can be used with chemical compositions such as:
YVO₄:Dy³⁺.

The luminescence center Fe³⁺ can be used with chemical compositions such as:
LiAlO₂:Fe³⁺.

The luminescence center Mn⁴⁺ can be used with chemical compositions such as:
6MgO·As₂O₅:Mn⁴⁺, 3.5MgO·0.5MgF₂·GeO₂:Mn⁴⁺.

The luminescence center Ce³⁺ can be used with chemical compositions such as:
Ca₂MgSi₂O₇:Ce³⁺ and Y₂SiO₅:Ce³⁺.

The luminescence center WO₄²⁻ can be used with chemical compositions such as:

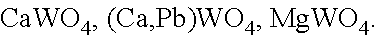

The luminescence center TiO₄⁴⁻ can be used with chemical compositions such as:

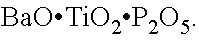

In various embodiments of this invention, the phosphor chemistry utilized in x-ray excitations can be used with or without energy augmentation structures. Of particular interest is the k-edge of these phosphors. Low energy excitation can lead to intense luminescence in materials with low k-edge. Some of these chemistries and the corresponding k-edge are included as follows:

| | |
|---|---|
| BaFCl:Eu²⁺ | 37.38 keV |
| BaSO₄:Eu²⁺ | 37.38 keV |
| CaWO₄ | 69.48 keV |
| Gd₂O₂S:Tb³⁺ | 50.22 keV |
| LaOBr:Tb³⁺ | 38.92 keV |
| LaOBr:Tm³⁺ | 38.92 keV |
| La₂O₂S:Tb³⁺ | 38.92 keV |
| Y₂O₂S:Tb³⁺ | 17.04 keV |
| YTaO₄ | 67.42 keV |
| YTaO₄:Nb | 67.42 keV |
| ZnS:Ag | 9.66 keV |
| (Zn,Cd)S:Ag | 9.66/26.7 keV |

In one embodiment of this invention, light from these materials (excited for example by high energy particles including x-rays, gamma rays, protons, and electrons) can have their emissions modulated by having those materials included in a vicinity of (including inside) the color enhancing structures described herein. For example, in medical treatments where x-ray excites phosphorescence to photostimulate reactions in a patient, simultaneous with irradiation by the high energy particles, there could be applied infrared irradiation to drive resonance in the energy augmentation structures described herein, where the x-ray phosphors would have enhanced light emissions when in the presence of the intensified electric fields. In another example, in medical or scientific instruments, for simultaneous with irradiation by the high energy particles, there could be applied electric fields to enhance emissions from these x-ray phosphors.

Electro Luminescent Materials: Various materials used for the electro-luminescence in the present invention with or without energy augmentation structures can include but are not limited to:
4,4′,4″-Tris[phenyl(m-tolyl)amino]triphenylamine (m-MTDATA)
N,N′-Bis(3-methylphenyl)-N,N′-diphenylbenzidine (TPD)
4,4′,4″-Tris[phenyl(m-tolyl)amino]triphenylamine (m-MTDATA)
N,N′-Bis(3-methylphenyl)-N,N′-diphenylbenzidine (TPD)
Tris-(8-hydroxyquinoline)aluminum

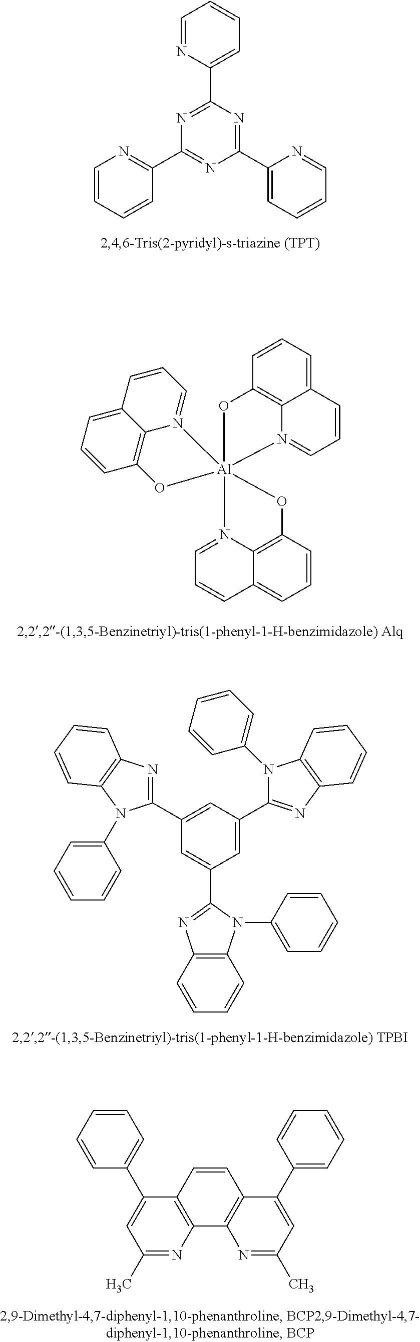

The invention in one embodiment provides an upconversion or a down conversion material configured, upon exposure to a first wavelength λ₁ of radiation, to generate a second wavelength λ₂ of radiation having an energy higher or lower than the first wavelength λ₁. The system can include a metallic structure (such as a plasmonics active metallic structure) disposed in relation to the nanoparticle (e.g. a metallic shell covering a fraction of the nanoparticle). The system may include a receptor disposed in the medium in proximity to the nanoparticle. The receptor upon activation by the second wavelength λ₂ may itself fluoresce producing visible light. In one embodiment of the invention, a physical characteristic of metallic structure (such as those described above and below in the drawings) is set to a value where a surface plasmon resonance in the metallic structure resonates at a frequency which provides spectral overlap with either the first wavelength λ₁ or the second wavelength λ₂. This system with a metallic structure disposed in relation to an up-conversion or a down-conversion nanoparticle becomes the energy converter utilized herein.

Within the context of the invention, the term “physical characteristic” of the metallic shell or core can relate to any characteristic of the metal itself or the shell or core dimensions or shape which affects the surface plasmon resonance frequency. Such physical characteristics can include, but are not limited to, a conductivity, a radial dimension, a chemical composition or a crystalline state of the metal shell or core.

In various embodiments, the metallic structures can be a metallic shell encapsulating at least a fraction of the nanoparticle in the metallic shell wherein a conductivity, a radial dimension, or a crystalline state of the metallic shell sets the surface plasmon resonance in the metallic structure to resonate at a frequency which provides spectral overlap with either the first wavelength λ₁ or the second wavelength λ₂. In various embodiments, the metallic structures can be a multi-layer metallic shell encapsulating at least a fraction of the nanoparticle in the metallic shell wherein a conductivity, a radial dimension, or a crystalline state of the metallic shell sets the surface plasmon resonance in the metallic structure to resonate at the first wavelength λ₁ and the second wavelength λ₂. This capability permits radiation at λ₁ and λ₂ to be amplified.

In various embodiments, the metallic structures can be a metallic particle existing in one or more multiple structures. These multiple structures can have a variety of shapes including for example sphere, spheroid, rod, cube, triangle, pyramid, pillar, crescent, tetrahedral shape, star or combination thereof disposed adjacent the nanoparticle wherein a conductivity, a dimension (e.g. a lateral dimension or a thickness), or a crystalline state of the metallic structure sets the surface plasmon resonance in the metallic particle or rod to resonate at a frequency which provides spectral overlap with either the first wavelength λ₁ or the second wavelength λ₂. Such shapes are described in the present figures and in the figures in U.S. Ser. No. 12/401,478 which is incorporated by reference in its entirety. The shape choice can affect the frequency of the surface plasmon resonance. It is known that the plasmon band is changed by the shape of nanoparticles (e.g., prolate and obloid spheroids).

The paper “Spectral bounds on plasmon resonances for Ag and Au prolate and oblate nanospheroids,” in the Journal of Nanophotonics, Vol. 2, 029501 (26 Sep. 2008), the entire contents of which are incorporated by reference, shows plasmon resonance shifts for shaping of Ag and plasmon resonance shifts for shaping of Au of prolate and obloid spheroids. In one embodiment of the invention, with an increasing aspect ratio for a metallic structure of the invention, the prolate spheroid resonance is red shifted relative to a sphere with no lower limit (under the assumptions of a Drude dispersion model). On the other hand, the oblate resonances are “blue shifted” as the spheroid becomes increasingly flat, but up to a limit.

In various embodiments, the metallic structures disposed in relation to an up-conversion or a down-conversion nanoparticle can be a metallic structure disposed interior to the nanoparticle wherein a conductivity or a dimension (e.g. a lateral dimension or a thickness) of the metallic structure sets the surface plasmon resonance in the metallic structure to resonate at a frequency which provides spectral overlap with either the first wavelength λ₁ or the second wavelength λ₂. In various embodiments, the metallic structures can be a metallic multi-layer structure disposed interior to the nanoparticle wherein a conductivity or a dimension (e.g. a lateral dimension or a thickness) of the metallic structure sets the surface plasmon resonance in the metallic structure to resonate at the first wavelength λ₁ and the second wavelength λ₂. This capability once again permits radiation at λ₁ and λ₂ to be amplified.

In another embodiment, the invention provides a nanoparticle structure including a sub 1000 nm dielectric core and a metallic structure disposed in relation to the nanoparticle. The dielectric core includes at least one of Y₂O₃, Y₂O₂S, NaYF₄, NaYbF₄, YAG, YAP, Nd₂O₃, LaF₃, LaCl₃, La₂O₃, TiO₂, LuPO₄, YVO₄, YbF₃, YF₃, Na-doped YbF₃, or SiO₂. Such nanoparticle structures can exhibit in certain embodiments surface plasmon resonance in the metallic structures to enhance upconversion of light from a first wavelength λ₁ to a second wavelength λ₂.

As described above, a shell (or other structure) is in particular designed with a layer thickness (or for example a lateral dimension) to enhance the photon upconversion process through plasmonic enhancement. The thickness of the shell (or other physical characteristic) is “tuned” in its thickness to the absorption process by having a dimension in which plasmons (i.e., electrons oscillations) in shell have a resonance in frequency which provides spectral overlap with the absorption band targeted. Thus, if the upconversion is to be stimulated by 980 nm NIR light, then the thickness of the shell is “tuned” in a thickness to where a plasmon resonance resonates at a frequency also of 980 nm (or in the neighborhood thereof as plasmon resonances are typically broad at these wavelengths).

A plasmon resonating shell can be made of numerous transition metals, including though not limited to gold, silver, platinum, palladium, nickel, ruthenium, rhenium, copper, and cobalt or a combination or alloys or layers thereof. Such a plasmon resonating shell can be also made of a combination of metals and non-metals. When formed of a gold nanoshell, the recommended thickness to resonate with 980 nm light is approximately 3.5 nm surrounding an 80 nm upconverting core, as projected by extended Mie theory calculations. (See Jain et al., Nanolett. 2007, 7(9), 2854 the entire contents of which are incorporated herein by reference.) FIG. 27 is reproduced from Jain et al and illustrates the capability in the invention to “tune” the metal shell to have a spectral overlap with the excitation and/or emission radiation wavelengths.

In one embodiment of the invention, the metallic structures disposed in relation to an up-conversion or a down-conversion nanoparticle can be an alloy such as for example a Au:Ag alloy. The alloy content can be set to adjust the frequency of the surface plasmon resonance. In one embodiment of the invention, the metallic structures can be an alloy such as for example a Pt:Ag alloy. The alloy content can be set to adjust the frequency of the surface plasmon resonance. In one embodiment of the invention, the metallic structures can be an alloy such as for example a Pt:Au alloy. The alloy content can be set to adjust the frequency of the surface plasmon resonance.

In one embodiment of the invention, the converter nanoparticle can be an alloy of two or more materials. In this embodiment, the alloy can have a composition between the two or more materials which is set to a compositional value where excitation of the alloy at first wavelength λ₁ produces emission at the second wavelength λ₂. In one embodiment of the invention, the nanoparticle can be a zinc sulfide and zinc selenide alloy. In one embodiment of the invention, the nanoparticle can be a zinc sulfide and cadmium sulfide alloy.

In one embodiment of the invention, the zinc sulfide and zinc selenide nanoparticle alloy can have an alloy content set to provide a predetermined surface plasmon resonance. In one embodiment of the invention, the zinc sulfide and cadmium sulfide nanoparticle alloy can have an alloy content is set to provide a predetermined surface plasmon resonance.

Some techniques for producing nanoparticles and nanoparticle alloys which are suitable for the invention are described in the following documents, all of which are incorporated herein in their entirety: U.S. Pat. Nos. 7,645,318; 7,615,169; 7,468,146; 7,501,092; U.S. Pat. Appl. Publ. No. 2009/0315446; 2008/0277270; 2008/0277267; 2008/0277268; and WO 2009/133138.

In one embodiment of the invention, the thickness of the metal shell disposed in relation to an up-conversion or a down-conversion nanoparticle is set depending on the absorption frequency (or in some cases the emission frequency) of the particular dopant ions in the dielectric core to enhance the total efficiency of the emission process of the upconverted light. Accordingly, the thickness of the shell can be considered as a tool that in one instance enhances the absorption of λ1, and in another instance can be considered as a tool that enhances the emission of λ₂, or in other situations can be considered an enhancement feature that in combination enhances the overall net process.

Additionally, plasmon-phonon coupling may be used to reduce a resonance frequency through the tuning of the bands to a degree off resonance. This may be useful in optimizing resonance energy transfer processes for the purpose of shifting the outputted color to a color desirable for a painted, colored, or displayed surface. In one example, FIG. 27 shows an example of the plasmon resonance shift as a function of shell thickness.

Here, in one embodiment of the invention, the capability to produce stimulated emission at a targeted wavelength or color or energy is complemented by the ability to design nanoparticles that have designed absorption bands. Such absorption materials could for example further serve to improve the monochromaticity of light observed from a paint, ink, dye, or otherwise reflecting surface treated with the color enhancing compositions of the invention.

Details of the preparation of this nanoparticle system are included in U.S. Ser. No. 12/725,108, the entire contents of which are incorporated herein by reference. The absorption spectrum of Y₂O₃ alone (lower trace) is fairly featureless, showing absorption due to the tri-arginine near 200 nm and a gentle slope associated with scattering and absorption by the Y₂O₃ nanoparticles extending into the visible portion of the spectrum. The gold-coated Y₂O₃ (upper trace), on the other hand, exhibit a strong absorption band at 546 nm, which is characteristic of the plasmonics resonance band due to the gold shell around the Y₂O₃ cores. The red-shifting of the plasmon absorption to 546 nm is consistent with the presence of a gold shell around a dielectric core.

In one embodiment of the invention, the converter materials for the upconverter dielectric core can include a wide variety of dielectric materials, as described above. In various embodiments of the invention, the upconverter dielectric core includes more specifically lanthanide doped oxide materials. Lanthanides include lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). Other suitable dielectric core materials include non-lanthanide elements such as yttrium (Y) and scandium (Sc). Hence. suitable dielectric core materials include Y₂O₃, Y₂O₂S, NaYF₄, NaYbF₄, Na-doped YbF₃, YAG, YAP, Nd₂O₃, LaF₃, LaCl₃, La₂O₃, TiO₂, LuPO₄, YVO₄, YbF₃, YF₃, or SiO₂. These dielectric cores can be doped with Er, Eu, Yb, Tm, Nd, Tb, Ce, Y, U, Pr, La, Gd and other rare-earth species or a combination thereof.

Lanthanides usually exist as trivalent cations, in which case their electronic configuration is (Xe) 4fⁿ, with n varying from 1 (Ce³⁺) to 14 (Lu³⁺). The transitions within the f-manifold are responsible for many of the photo-physical properties of the lanthanide ions, such as long-lived luminescence and sharp absorption and emission lines. The f-electrons are shielded from external perturbations by filled 5s and 5p orbitals, thus giving rise to line-like spectra. The f-f electronic transitions are LaPorte forbidden, leading to long excited state lifetimes, in the micro- to millisecond range.

Accordingly, examples of doped materials in the invention include oxides such as yttrium oxide and neodymium oxide and aluminum oxide as well as sodium yttrium fluoride and nanocrystalline perovskites and garnets such as yttrium aluminum garnet (YAG) and yttrium aluminum perovskite (YAP). Of these materials, doping is required for some, but not all of these materials, for promoting upconversion efficiencies. In various embodiments of the invention, the host nanocrystals are doped with trivalent rare earth lanthanide ions from those lanthanide series elements given above.

More specifically, in various embodiments of the invention, pairs of these dopants are introduced in order to make accessible more energy states in the host crystal. The activation and pumping of these energy states follows closely the principles discussed above. Doping concentrations in the invention can range from 0.2% to 20% roughly per ion into the host lattice or in a weight or mol % variation. The efficiency of the upconversion processes of specific bands in these materials can be modulated by the percentages doped to induce and enhance targeted emissions. Lanthanide doped upconverters while not limited to, can use the following mol percent dopant compositions: 5% Er, 10% Yb, 0.2% Tm+3% Yb, and 1% Er+10% Yb.

The size of the nanocrystal will also have an effect on the efficiency of the upconversion process, as a larger nanocrystal will have more sites for dopant ions to be accommodated into the host lattice, therefore enabling more emissions from the same doped host than if the nanocrystal were smaller. While the dopant percentages listed above are not rigidly fixed, these numbers provide a rudimentary teaching of the typical percentages one would use in obtaining a particular dielectric core material of the invention.

Moreover, some of these host crystals (e.g., neodymium oxide) in one embodiment of the invention may require no specific doping to facilitate upconversion, which has been seen in one instance in Nd₂O₃ with an excitation wavelength of 587 nm producing emissions at 372 nm, 402 nm, and 468 nm. See Que, W et al. Journal of Applied Physics 2001, vol 90, pg. 4865, the entire contents of which are incorporated herein by reference. Doping neodymium oxide with Yb³⁺, in one embodiment of the invention, would enhance upconversion through sensitizing the Nd³⁺ ions with a lower energy Yb³⁺ activator.

In one embodiment of the invention, the dielectric core is coated, such as for example with a metallic shell, to enhance electron-phonon coupling and thereby increase up conversion or down conversion efficiency, as discussed above. In another embodiment of the invention, the shell can include a SiO₂- and/or TiO₂-coating, and this coating is in one embodiment coated on doped Y₂O₃ upconverting nanoparticles to thereby, in some instances, increase the upconversion efficiency relative to an uncoated nanocrystal. In another embodiment of the invention, the shell can include a SiO₂- and/or TiO₂-coating, and this coating is in one embodiment coated on doped Y₂O₃ down converting nanoparticles to thereby, in some instances, increase the down conversion efficiency relative to an uncoated nanocrystal. Further, in one embodiment of the invention, the coating can be a polymer. In one embodiment, this coating is provided on NaYF₄:Ln/NaYF₄ dielectric core. Such coatings can increase the upconversion efficiency relative to an uncoated upconverter.

In another embodiment of the invention, phonon modes of undoped host-lattice (e.g., Y₂O₃) nanocrystals are modulated, for example, by Au, Ag, Pt, and Pd shells of varying thicknesses. In various embodiments of the invention, the upconverter dielectric core and the shell system includes as upconverting nanocrystals Y₂O₃:Ln with NaYF₄ shells, Y₂O₃:Ln with Au(Ag,Pt) shells, NaYF₄:Ln with Y₂O₃ shells, NaYF₄:Ln with Au(Ag,Pt) shells. In this system, the core diameter and shell outer/inner diameter of the metallic coatings can be set to dimensions that are expected to be tunable to a plasmon mode overlap.

In other embodiments as discussed below, the metal coating or the metallic structure disposed in relation to an up-conversion or a down-conversion nanoparticle can exist inside the dielectric and the relative position of the metal structure to the dielectric structure can enhance plasmon resonance. These structures with the metallic structure inside can be referred to as a metallic core up converter or a metallic core down converter. The metallic core technique for energy conversion is useful since it takes advantage of metal nano-particles that have improved surface morphology compared to shell coatings on core dielectrics. The metal or metallic alloy in the inner core metallic energy converter can be selected to tune its plasmonic activity. These structures with the metallic structure outside can be referred to as a core up converter or a core down converter.

In various embodiments of the invention, the upconverter or down converter dielectric core can be coated with thiol-terminated silanes to provide a coating of SiO₂ about the core of similar reactivity to Y₂O₃. In one embodiment of the invention, the above-described methodology is used to synthesize core-shell nanoparticles of Y₂O₃:Ln with NaYF₄ shells, Y₂O₃:Ln with Au(Ag,Pt) shells, NaYF₄:Ln with Y₂O₃ shells, NaYF₄:Ln with Au(Ag,Pt) shells where core and shell diameters varying from 2 to 20 nm. In these material systems, the tuned ratio of core-to-shell diameter may permit a plasmon-phonon resonance which should amplify absorption of NIR light and/or upconverted emission. In these material systems, control of the core and shell diameters is one factor determining the size dependent effect and subsequent tuning of plasmon-phonon resonance.

In one embodiment of the invention, the upconverter dielectric core can be mixed core-shell materials including for example semiconducting Y₂O₃ and NaYF₄ cores doped with various Ln series metals, which have been shown to possess large upconverting efficiencies. These doped Y₂O₃ and NaYF₄ cores will have shells of Au(Ag,Pt, Pd) or undoped Y₂O₃ and NaYF₄ matrices which have the potential to enhance or tune the phonon modes needed for energy transfer in the upconversion process. Solubility can be enhanced, for example, by addition of thiolated organics (Au shell), organic chain triethanolsilane (Y₂O₃ shell), and trioctylphosphine-oleic amine (NaYF₄ shell). All core-shell nanoparticles may further be solubilized into a colloidal suspension with the addition of triarginine peptide, polyethylene glycol, and polyethyleneimine surfactants.

In various embodiments of the invention, multi-layer metallic nanoshells discussed in this application have the potential capability to enhance electromagnetically two spectral regions. Accordingly, the metallic structures of the invention can be used in the upconverting mode to enhance both the excitation at wavelength λ₁ and the emission at wavelength λ₂. This feature also can be used in the down converting to enhance primarily the emission at wavelength λ₂ and potentially the excitation at wavelength λ₁.

Such metallic structures in various embodiments of the invention include conducting materials made for example of metals, or doped glasses or doped semiconductors. These conducting materials can be in the form of pure or nearly pure elemental metals, alloys of such elemental metals, or layers of the conducting materials regardless of the constituency. The conducting materials can (as noted above) include non-metallic materials as minor components which do not at the levels of incorporation make the composite material insulating.

Similarly, in various embodiments of the invention, the up or down converting materials can include at least one of a dielectric, a glass, or a semiconductor. The up or down converting materials can include an alloy of two or more dielectric materials, an alloy of two or more glasses, or an alloy of two or more semiconductors.

With the upconverter and down converter structures of the invention, a plasmonics effect can be advantageous. A plasmonics effect can increase the local intensity of the received light or the local intensity of the emitted light from the up and/or down converter structures of the invention. A plasmonics effect can occur throughout the electromagnetic region provided the suitable nanostructures, nanoscale dimensions, metal types are used. Plasmonic effects are possible over a wide range of the electromagnetic spectrum, ranging from gamma rays and X rays throughout ultraviolet, visible, infrared, microwave and radio frequency energy. However, for practical reasons, visible and NIR light are used for metal structures such as for example silver and gold nanoparticles, since the plasmon resonances for silver and gold occur in the visible and NIR region, respectively.

In various embodiments, nanoparticles of neodymium and ytterbium doped yttrium oxide, europium and ytterbium doped yttrium oxide, and any combination of rare earth trivalent ions doped into a neodymium oxide nanocrystal can be used. The dual doped yttrium oxide of composition neodymium and ytterbium and also the dual doped europium and ytterbium are new for the yttrium oxide host lattice, although such dual doped systems have been shown to work in other host lattices such as YAG.

These dual doped lanthanide glasses have been shown to upconvert efficiently on bulk materials, and thereby can provide new upconverter structures at the nano-scale. There are advantages offered by these yttrium oxide nanostructures of the invention. The small scale synthetic methodology for creating nanoscale yttrium oxide is easier to control and produce in yttrium oxide than in YAG. The host structure of yttrium oxide scintillates by down conversion. These combinations of dopants in yttrium oxide for example can provide predetermined emission colors for the yttrium oxide nanocrystal for the color shifting of the invention.

In one embodiment of the invention, a dual dopant permits excitation of either ion in the host glass. For instance, excitation by 980 nm light excites an ytterbium ion, where through transfer of energy from one excited state of the ytterbium ion to another dopant provides a mechanism for upconversion emission of light in the visible and NIR spectral regions.

As noted above, semiconductor nanoparticles (e.g., quantum dots) can be used with or without the energy augmentation structures. The terms “semiconductor nanoparticles,” in the art refers to an inorganic crystallite between 1 nm and 1000 nm in diameter, preferably between 2 nm to 50 nm. A semiconductor nano-particle is capable of emitting electromagnetic radiation upon excitation (i.e., the semiconductor nano-particle is luminescent). The nanoparticle can be either a homogeneous nano-crystal, or comprises of multiple shells. For example, the nanoparticle can include a “core” of one or more first semiconductor materials, and may be surrounded by a “shell” of a second semiconductor material. The core and/or the shell can be a semiconductor material including, but not limited to, those of the group II-VI (ZnS, ZnSe, ZnTe, CdS, CdSe, CdTe, HgS, HgSe, HgTe, MgS, MgSe, MgTe, CaS, CaSe, CaTe, SrS, SrSe, SrTe, BaS, BaSe, BaTe, and the like) and III-V (GaN, GaP, GaAs, GaSb, InN, InP, InAs, InSb, and the like) and IV (Ge, Si, and the like) materials, and an alloy or a mixture thereof.

Fluorescent organometallic molecules containing rare earth or transitional element cations can be used for down conversion materials with or without the energy augmentation structures. Such molecules include a metal center of rare earth elements including Eu, Tb, Er, Tm, Ce protected with organic chelating groups. The metal center may also include transitional elements such as Zn, Mn, Cr, Ir, etc. and main group elements such as B, Al, Ga. Such organometallic molecules can readily dissolve in liquid or transparent solid host media. Some examples of such fluorescent organometallic molecules include: 1. Tris(dibenzoylmethane)mono(phenanthroline)europium(III); 2. Tris(8-hydroxyquinoline)erbium; 3. Tris(1-phenyl-3-methyl-4-(2,2-dimethylpropan-1-oyl)pyrazolin-5-one)terbium(III); 4. Bis(2-methyl-8-hydroxyquinolato)zinc; 5. Diphenylborane-8-hydroxyquinolate.

Specific examples of down-conversion materials for red emission include those discussed above and europium complexes such as those described in JP Laid-open Patent Publication (Kokai) No. 2003-26969, constructed such that β-diketone ligand is coordinated to europium forming an europium complex capable of emitting red fluorescence. Other specific examples of the rare earth element complexes include complexes include lanthanum (Ln), europium (Eu), terbium (Tb), and gadolinium (Gd) and combinations thereof. A europium (Eu) complex is capable of emitting red fluorescence when irradiated with ultraviolet rays having a wavelength ranging from 365 nm to 410 nm. Terbium (Tb) is capable of emitting green fluorescence when irradiated with ultraviolet rays having a wavelength of 365 nm.

In other down-conversion embodiments with or without the energy augmentation structures, the down conversion materials which emit red light may include europium, light emitting particles which emit green light may include Terbium, and light emitting particles which emit blue or yellow light may include cerium (and/or thulium). In up-conversion embodiments, up conversion materials which emit red light may include praseodymium, light emitting particles which emit green light may include erbium, and light emitting particles which emit blue light may include thulium. In embodiments, the conversion materials can be light emitting particles made of fluorescent molecules that emit different colors (e.g. red, green, and blue). In embodiments, the conversion materials can be light emitting particles made of pure organic or organo-metallic dyes with or without the energy augmentation structures.

In addition to the combinations of rare earth complexes, such as a combination of a europium complex and a terbium complex, it is also possible employ a combination of a europium complex and a green-emitting fluorescent substance which is not a complex, or a combination of a terbium complex and a red-emitting fluorescent substance which is not a complex.

Other down converter materials with or without the energy augmentation structures include for example ZnS, PbS, SbS₃, MoS₂, PbTe, PbSe, BeO, MgO. Li₂CO₃, Ca(OH)₂, MoO₃, SiO₂, Al₂O₃, TeO₂, SnO₂, KBr, KCl, and NaCl. These materials can include dopants to tailor the emission properties, as noted above. Examples of doped (or alloyed) glass systems suitable for the include Y₂O₃:Gd, Y₂O₃:Dy, Y₂O₃:Tb, Y₂O₃:Ho, Y₂O₃:Er, Y₂O₃:Tm, Gd₂O₃:Eu, Y₂O₂S:Pr, Y₂O₂S:Sm, Y₂O₂S:Eu, Y₂O₂S:Tb, Y₂O₂S:Ho, Y₂O₂S:Er, Y₂O₂S:Dy, Y₂O₂S:Tm, ZnS:Ag:Cl (blue), ZnS:Cu:Al (green), Y₂O₂S:Eu (red), Y₂O₃:Eu (red), YVO₄:Eu (red), and Zn₂SiO₄:Mn (green).

With regard more specifically to down converter materials suitable for the invention with or without the energy augmentation structures, U.S. Pat. No. 4,705,952 (the contents of which are hereby incorporated herein by reference) describes an infrared-triggered phosphor that stores energy in the form of visible light of a first wavelength and released energy in the form of visible light of a second wavelength when triggered by infrared light. The phosphors in U.S. Pat. No. 4,705,952 were compositions of alkaline earth metal sulfides, rare earth dopants, and fusible salts. The phosphors in U.S. Pat. No. 4,705,952 were more specifically phosphors made from strontium sulfide, barium sulfide and mixtures thereof, including a dopant from the rare earth series and europium oxide, and mixtures thereof; and including a fusible salt of fluorides, chlorides, bromides, and iodides of lithium, sodium, potassium, cesium, magnesium, calcium, strontium, and barium, and mixtures thereof. The materials described in U.S. Pat. No. 4,705,952 are useful in various embodiments of the invention with or without the energy augmentation structures.

In other embodiments of the invention, the down converter materials (or mixtures of down converters materials can include Y₂O₃:Li. Sun et al “Luminescent properties of Li+ doped nanosized Y₂O₃:Eu,” Solid State Comm. 119 (2001) 393-396 (the entire contents of which are incorporated herein by reference) describe such materials. Hou et al “Luminescent properties nano-sized Y₂O₃:Eu fabricated by co-precipitation method,” Journal of Alloys and Compounds, vol. 494, issue 1-2, 2 Apr. 2010, pages 382-385 (the entire contents of which are incorporated herein by reference) describe that nano-sized yttria (Y₂O₃) powders have been successfully synthesized by a co-precipitation method. The powders were well crystallized, and the grains were almost spherical with good dispersibility. The quenching concentration of Eu³⁺ ions is 9 mol % which is much higher than micro-scaled powders. The incorporation of Li+ ions greatly improved the luminescence intensity. The highest emission intensity was observed with 4 mol % Li+ doped Y₂O₃:Eu powder ((Y_{0.87}Eu_{0.09}Li_{0.04})₂O₃) and the fluorescence intensity was increased by as much as 79%. Yi et al “Improved cathodoluminescent characteristics of Y₂O₃:Eu³⁺ thin films by Li-doping,” Appl. Phys. A 87, 667-671 (2007) (the entire contents of which are incorporated herein by reference) describe cathodoluminescent spectra for both Y₂O₃:Eu³⁺ and Li-doped Y₂O₃:Eu³⁺ films and methods for making these materials.

The invention in other embodiments can use a wide variety of up conversion materials (or mixtures of up converters) with or without the energy augmentation structures to enhance a particular color of light observable from reflective material or surface. These up conversion materials can include similar materials as discussed above with regard to down conversion but typically included doped or impurity states in a host crystal that provide a mechanism for up conversion pumping. Accordingly, the up conversion materials to enhance color emission can convert energy from one of near infrared, infrared, and microwave irradiation. The upconversion materials to enhance color emission can convert energy from lower energy visible light to higher energy visible light.

Upconversion materials with or without the energy augmentation structures can be used in various ways to enhance visible light emission by way of conversion of infrared light from a solar spectrum (as in daylight exposure) or a black body spectrum (as in an incandescent lamp). In one example, a nanoparticle of a lanthanide doped oxide can be excited with near infrared light such as laser light at 980 nm and 808 nm to produce visible light in different parts of the red, green, blue spectrum depending on the dopant trivalent rare earth ion(s) chosen, their concentration, and the host lattice.

The lanthanide doped oxides suitable for this invention differ from more traditional multi-photon up conversion processes where the absorption of, for example, two photons is needed in a simultaneous event to promote an electron from a valence state directly into an upper level conduction band state where relaxation across the band gap of the material produces fluorescence. Here, the co-doping produces states in the band gap of the NaYF₄ such that the Yb³⁺ ion has an energy state at ²F_{5/2} pumpable by a single photon event and from which other single photon absorption events can populate even higher states. Once in this exited state, transitions to higher energy radiative states are possible, from which light emission will be at a higher energy than that of the incident light pumping the ²F_{5/2} energy state. In other words, the energy state at ²F_{5/2} of the Yb³⁺ ion is the state that absorbs 980 nm light permitting a population build up serving as the basis for the transitions to the higher energy states such as the ⁴F_{7/2} energy state. Here, transitions from the ⁴F_{7/2} energy state produce visible emissions.

U.S. Pat. No. 7,008,559 (the entire contents of which are incorporated herein by reference) describes the upconversion performance of ZnS where excitation at 767 nm produces emission in the visible range. The materials described in U.S. Pat. No. 7,008,559 (including the ZnS as well as Er³⁺ doped BaTiO₃ nanoparticles and Yb³⁺ doped CsMnCl₃) are suitable in various embodiments of the invention with or without the energy augmentation structures.

Further, materials specified for up conversion materials in the invention with or without the energy augmentation structures include CdTe, CdSe, ZnO, CdS, Y₂O₃, MgS, CaS, SrS and BaS. Such up conversion materials may be any semiconductor and more specifically, but not by way of limitation, sulfide, telluride, selenide, and oxide semiconductors and their nanoparticles, such as Zn₁₋ₓMnₓS_{y}, Zn₁₋ₓMnₓSe_{y}, Zn₁₋ₓMnₓTe_{y}, Cd₁₋ₓMnS_{y}, Cd₁₋ₓMnₓSe_{y}, Cd₁₋ₓMnₓTe_{y}, Pb₁₋ₓMnₓS_{y}, Pb₁₋ₓMnₓSe_{y}, Pb₁₋ₓMnₓTe_{y}, Mg₁₋ₓMnS_{y}, Ca₁₋ₓMnₓS_{y}, Ba₁₋ₓMnₓS_{y} and Sr₁₋ₓ, etc. (wherein, 0<x≤1, and 0<y≤1). Complex compounds of the above-described semiconductors are also contemplated for use in the invention—e.g. (M_{1-z}N_{z})₁₋ₓMnₓA_{1-y}B_{y} (M=Zn, Cd, Pb, Ca, Ba, Sr, Mg; N=Zn, Cd, Pb, Ca, Ba, Sr, Mg; A=S, Se, Te, O; B=S, Se, Te, O; 0<x≤1, 0<y≤1, 0<z≤1). Two examples of such complex compounds are Zn_{0.4}Cd_{0.4}Mn_{0.2}S and Zn_{0.9}Mn_{0.1}S_{0.8}Se_{0.2}. Additional conversion materials include insulating and nonconducting materials such as BaF₂, BaFBr, and BaTiO₃, to name but a few exemplary compounds. Transition and rare earth ion co-doped semiconductors suitable for the invention include sulfide, telluride, selenide and oxide semiconductors and their nanoparticles, such as ZnS; Mn; Er; ZnSe; Mn, Er; MgS; Mn, Er; CaS; Mn, Er; ZnS; Mn, Yb; ZnSe; Mn,Yb; MgS; Mn, Yb; CaS; Mn,Yb etc., and their complex compounds: (M_{1-z}N_{z})₁₋ₓ(Mn_{q}R_{1-q})ₓA_{1-y}B_{y} (M=Zn, Cd, Pb, Ca, Ba, Sr, Mg; N=Zn, Cd, Pb, Ca, Ba, Sr, Mg; A=S, Se, Te, O; B=S, . . . 0<z≤1, o<q≤1).

Some nanoparticles such as ZnS:Tb³⁺, Er³⁺; ZnS:Tb³⁺; Y₂O₃:Tb³⁺; Y₂O₃:Tb³⁺, Er³⁺; ZnS:Mn²⁺; ZnS:Mn,Er³⁺ are known in the art to function for both down-conversion luminescence and upconversion luminescence and would be suitable for the invention with or without the energy augmentation structures. In up-conversion embodiments, light emitting particles which emit red light may include praseodymium, light emitting particles which emit green light may include erbium, and light emitting particles which emit blue light may include thulium.

In general, the upconversion process generally requires one of more rare-earth dopants, such as Er, Eu, Yb, Tm, Nd, Tb, Ce, Y, U, Pr, La, Gd and other rare-earth species or a combination thereof, doped into a dielectric crystal (of any size >0.1 nm), including at least one of Y₂O₃, Y₂O₂S, NaYF₄, NaYbF₄, YAG, YAP, Nd₂O₃, LaF₃, LaCl₃, La₂O₃, TiO₂, LuPO₄, YVO₄, YbF₃, YF₃, Na-doped YbF₃, or SiO₂, where incident radiation is at longer wavelength than emissive radiation from the crystal. The wavelength emitted in based entirely on the dopant ion(s) chosen and their associated and relative concentration in the host crystal. For the example of upconversion in a Y₂O₃ host crystal, to achieve a blue emission (~450-480 nm) one could synthesize [Y₂O₃; Yb (3%), Tm (0.2%)], where the Yb and Tm are the percentages doped in the crystal relative to the Y atoms being 100%. Likewise, typical green upconversion materials are [Y₂O₃; Yb (5%), Ho (1%)] and [Y₂O₃; Yb (2%), Er (1%)], and typical red upconversion materials are [Y₂O₃; Yb (10%), Er (1%)] and [Y₂O₃; Yb (5%), Eu (1%)]. The concentrations of dopants relative to each other and the crystal matrix must be tuned for every combination, and there are multiple ways to achieve multiple colors from even the same dopants with or without the energy augmentation structures.

Up-conversion of red light with a wavelength of about 650 nm in Tm³⁺ doped flourozirconate glasses can be used in the invention to produce blue light. In this system, the blue light consists of two emission bands; one at 450 nm which is ascribed to the 1D2→3H4 transition, the others at 475 nm is ascribed to the 1G4→3H6 transition. The emission intensities of both bands have been observed by others to vary quadratically with the excitation power. For glasses with a Tm³⁺ concentration of 0.2 mol % and greater, cross-relaxation processes occur which decrease the up-conversion efficiency.

The emission of visible light upon excitation in the near-infrared (NIR) has been observed in optically clear colloidal solutions of LuPO₄:Yb³⁺, Tm³⁺, and YbPO₄:Er³⁺ nanocrystals in chloroform. Excitation at 975 nm has been shown by others to produce visible luminescence in the blue, green, or red spectral regions.

Tellurium and germanium oxides (tellurites and germinates) are also suitable upconverters. These glasses can be doped with Tm, Yb, Ho, Er, Pr, for example.

Yb³⁺ doped BaZrO₃ is also suitable for upconversion. Er³⁺ and/or Tm³⁺ doping are also suitable for tailoring the emission wavelengths.

In another embodiment, Nd³⁺:Cs₂NaGdCl₆ and Nd³⁺, Yb³⁺:Cs₂NaGdCl₆ polycrystalline powder samples prepared by Morss method have been reported to be up converters and are suitable for the present invention. These materials, under 785 nm irradiation, have shown upconversion emissions near 538 nm (Green), 603 nm (Orange), and 675 nm (Red) were observed and assigned to 4G7/2→4I9/2, (4G7/2→4I11/2; 4G5/2→4I9/2), and (4G7/2→4I13/2; 4G5/2→4I11/2), respectively.

In another embodiment, Nd³⁺ and Ho³⁺ co-doped-based ZrF₄ fluoride glasses under 800 nm excitation have been reported to be up converters and are suitable for the present invention. Among the up-conversion luminescences for the ZrF₄ fluoride glasses, the green emission was seen to be extremely strong and the blue and red emission intensities were very weak.

In another embodiment, Tm³⁺/Yb³⁺-codoped TeO₂—Ga₂O₃—R₂O (R=Li, Na, K) glasses have been reported to be up converters and are suitable for the present invention. These materials, under excitation at 977 nm, showed intense blue upconversion emission centered at 476 nm along with a weak red emission at 650 nm.

In another embodiment, metal-to-ligand charge transfer (MLCT) transition in [Ru(dmb)₃]²⁺ (dmb=4,4′-dimethyl-2,2′-bipyridine) in the presence of anthracene or 9,10-diphenylanthracene have been reported converters and are suitable for the present invention. Upconverted to be up converters and are suitable for the present invention. Upconverted singlet fluorescence resulting from triplet-triplet annihilation at low excitation power has been reported. In particular 9,10-diphenylanthracene (DPA) (substituted for anthracene) showed higher efficiencies for upconversion. In these experiments, workers with this material system assumed that DPA's increased singlet fluorescence quantum yield (=0.95) relative to anthracene (=0.27)7. This work lead to an approximate 24.4±6.1 enhancement of green-to-blue light upconversion permitting direct visualization of the process at low excitation power, for example by a commercial green laser pointer (λₑₓ=532 nm, <5 mW peak power).

TABLE 1 shows a list of other suitable phosphors:

| | | Emission | | | | | | |
|---|---|---|---|---|---|---|---|---|
| | | Spectrum | X-ray Absorption | | | Microstructure | | |
| | | Peak Emission | Emiss Eff | Eff | K-edge | Specific | Crystal | |
| # | Phosphor | (nm) | (%) | (Z) | (keV) | Gravity | Structure | Hygroscopic |
| 1 | BaFCl: Eu²⁺ | 380 | 13 | 49.3 | 37.38 | 4.7 | Tetragonal | N |
| 2 | BaSO₄—: Eu²⁺ | 390 | 6 | 45.5 | 37.38 | 4.5 | Rhombic | N |
| 3 | LaOBr: Tm³⁺ | 360, 460 | 14 | 49.3 | 38.92 | 6.3 | Tetragonal | N |
| 4 | YTaO₄ | 337 | | 59.8 | 67.42 | 7.5 | Monolithic | N |
| 5 | YTaO₄: Nb (*) | 410 | 11 | 59.8 | 67.42 | 7.5 | Monolithic | N |
| 6 | CaWO₄ | 420 | 5 | 61.8 | 69.48 | 6.1 | Tetragonal | N |
| 7 | LaOBr: Tb³⁺ | 420 | 20 | 49.3 | 38.92 | 6.3 | Tetragonal | N |
| 8 | Y₂O₂S: Tb³⁺ | 420 | 18 | 34.9 | 17.04 | 4.9 | Hexgonal | N |
| 9 | ZnS: Ag | 450 | 17 | 26.7 | 9.66 | 3.9 | Hexgonal | N |
| 10 | (Zn,Cd)S: Ag | 530 | 19 | 38.4 | 9.66/26.7 | 4.8 | Hexgonal | N |
| 11 | Gd₂O₂S: Tb³⁺ | 545 | 13 | 59.5 | 50.22 | 7.3 | Hexgonal | N |
| 12 | La₂O₂S: Tb³⁺ | 545 | 12.5 | 52.6 | 38.92 | 6.5 | Hexgonal | N |

In one embodiment of the invention, besides the YTaO₄, noted above, other energy converters can include phosphors were obtained from the following sources. “Ruby Red” obtained from Voltarc, Masonlite & Kulka, Orange, Conn., and referred to as “Neo Ruby”; “Flamingo Red” obtained from EGL Lighting. Berkeley Heights, N.J, and referred to as “Flamingo”; “Green” obtained from EGL Lighting, Berkeley Heights, N.J. and referred to as “Tropic Green”; “Orange” obtained from Voltarc, Masonlite & Kulka. Orange, Conn, and referred to as “Majestic Orange”; “Yellow” obtained from Voltarc. Masonlite & Kulka, Orange. Conn., and referred to as “Clear Bright Yellow.” The “BP” phosphors are shown in detail below in TABLE 2:

| | | Emission | | | | Denisty | | |
|---|---|---|---|---|---|---|---|---|
| | | Spectrum | X-Ray Absorption | | | g/cc | Xtal | |
| | Phosphor Material | Peak Emission | Emiss Eff | Eff | K-edge | Specific | Crystal | |
| Code | Color | (nm) | (%) | (Z) | (keV) | Gravity | Structure | Hygroscopic |
| BP1 | CaWO4: Pb | 425 | | | | | | N |
| BP2 | Y2SiOS: Ce | 410 | | | | | | N |
| BP3 | YTaO4 | 337 | 10 | 59.8 | 67.42 | 7.5 | Monolithic | N |
| BP3-C | YTaO4 | 337 | 10 | 59.8 | 67.42 | 7.5 | Monolithic | N |
| BP4 | BASF-1 | 460 | | | | | | |
| BP5 | BASF-2 | 490 | | | | | | |
| BP6 | YTaO4: Nb (*) | 410 | 11 | 59.8 | 67.42 | 7.5 | Monolithic | N |
| BP6-C | YTaO4: Nb (*) | | | | | | | |
| BP7-C | LaOBr: Tm3+ (coated) | 360, 460 | 14 | 49.3 | 38.92 | 6.3 | Tetragonal | N |
| BP8-C | Laf3: Ce | 280 | | | | | | |
| BP9 | Y2O3 | 365 | | | | | | |
| BP-10 | BaSO4—: Eu2+ (coated) | 390 | 6 | 45.5 | 37.38 | 4.5 | Rhombic | N |
| BP10-C | BaSO4—: Eu2+ (coated) | 390 | 6 | 45.5 | 37.38 | 4.5 | Rhombic | N |
| BP11 | LaOCl: Tm | | | | | | | |
| BP12 | Y2O2S: Tm | | | | | | | |
| BP13 | BaSi2O5: Pb2+ | 350 | | | | | | N |
| | SrB6O10: Pb | 360 | | | | | | N |
| | CsI: Na (Coated) | 338 | | | | | | Y |
| | Gd2O2S: Tm | Blue to Green | | | | | | Y |

The “BP” phosphors are available from PhosphorTech Corporation of Kennesaw, Ga., from BASF Corporation, or from Phosphor Technology Ltd, Norton Park, Norton Road Stevenage, Herts, SG1 2BB, England.

Other useful energy converters include semiconductor materials including for example TiO₂, ZnO, and Fe₂O₃ which are biocompatible, and CdTe and CdSe which would preferably be encapsulated because of their expected toxicity. Other useful energy converters include ZnS, CaS, BaS, SrS and Y₂O₃ which are less toxic. Other suitable energy converters which would seem the most biocompatible are zinc sulfide, ZnS:Mn²⁺, ferric oxide, titanium oxide, zinc oxide, zinc oxide containing small amounts of Al₂O₃ and AgI nanoclusters encapsulated in zeolite. For non-medical applications, where toxicity may not be as critical a concern, the following materials (as well as those listed elsewhere) are considered suitable: lanthanum and gadolinium oxyhalides activated with thulium; Er³⁺ doped BaTiO₃ nanoparticles. Yb³⁺ doped CsMnCl₃ and RbMnCl₃. BaFBr:Eu²⁺ nanoparticles, cesium iodide, bismuth germanate, cadmium tungstate, and CsBr doped with divalent Eu.

In various embodiments of the invention, the following luminescent polymers are also suitable as energy converters: poly(phenylene ethynylene), poly(phenylene vinylene), poly(p-phenylene), poly(thiophene), poly(pyridyl vinylene), poly(pyrrole), poly(acetylene), poly(vinyl carbazole), poly(fluorenes), and the like, as well as copolymers and/or derivatives thereof.

As a non-limiting list, the following are also suitable energy converters: Y₂O₃ ZnS; ZnSe; MgS; CaS; Mn, Er ZnSe; Mn, Er MgS; Mn, Er CaS; Mn, Er ZnS; Mn, Yb ZnSe; Mn, Yb MgS; Mn, Yb CaS; Mn, Yb ZnS:Tb³⁺, Er³⁺; ZnS:Tb³⁺; Y₂O₃:Tb³⁺; Y₂O₃:Tb³⁺, Er³⁺; ZnS:Mn²⁺; ZnS:Mn,Er³⁺; CaWO₄, YaTO₄, YaTO₄:Nb, BaSO₄:Eu, La₂O₂S:Tb, BaSi₂O₅:Pb, NaI(Tl), CsI(Tl), CsI(Na), CsI(pure), CsF, KI(Tl), LiI(Eu), BaF₂, CaF, CaF₂(Eu), ZnS(Ag), CaWO₄, CdWO₄, YAG(Ce) (Y₃Al₅O₁₂(Ce)), BGO bismuth germanate, GSO gadolinium oxyorthosilicate, LSO lutetium oxyorthosilicate. LaCl₃(Ce). LaBr₃(Ce). LaPO₄; Ce, Tb (doped). Zn₂SiO₄:Mn with Mn doped between 0.05-10%, and YTaO₄.

TABLE 3

| | Emission | | | X-Ray | | | |
|---|---|---|---|---|---|---|---|
| | Spectrum | Emiss | | Absorption | | | |
| Phosphor | Peak Emission | Eff | Eff | K-edge | Specific | Crystal | |
| Color | (nm) | (%) | (Z) | (keV) | Gravity | Structure | Hygroscopic |
| Zn3(PO4)2: Tl+ | 310 | | | | | | N |
| BaF2 | 310 | | | | | | Slightly |
| CsI | 315 | | | | | | N |
| Ca3(PO4)2: Tl+ | 330 | | | | | | N |
| YTaO4 | 337 | | 59.8 | 67.42 | 7.5 | Monolithic | N |
| CsI: Na | 338 | | | | | | Y |
| BaSi2O5: Pb2+ | 350 | | | | | | N |
| Borosilicate | 350 | | | | | | N |
| LaCl3(Ce) | 350 | | | | | | Y |
| SrB4O7F: Eu2+ | 360 | | | | | | N |
| RbBr: Tl+ | 360 | | | | | | |
| (Ba, Sr, | 370 | | | | | | N |
| Mg)3Si2O7: Pb2+ | | | | | | | |
| YAlO3: Ce3+ | 370 | | | | | | N |
| BC-422 | 370 | | | | | Organic | ? |
| BaFCl: Eu2+ | 380 | 13 | 49.3 | 37.38 | 4.7 | Tetragonal | N |
| BaSO4—: Eu2+ | 390 | 6 | 45.5 | 37.38 | 4.5 | Rhombic | N |
| BaFBr: Eu2+ | 390 | | | | | | ? |
| BC-420 | 391 | | | | | Organic | ? |
| BC-414 | 392 | | | | | Organic | ? |
| SrMgP2O7: Eu2+ | 394 | | | | | | N |
| BaBr2: Eu2+ | 400 | | | | | | N |
| (Sr, | 400 | | | | | | N |
| Ba)Al2Si2O8: Eu2+ | | | | | | | |
| YTaO4: Nb (*) | 410 | 11 | 59.8 | 67.42 | 7.5 | Monolithic | N |
| Y2SiO5: Ce3+ | 410 | | | | | | N |
| CaWO4 | 420 | 5 | 61.8 | 69.48 | 6.1 | Tetragonal | N |
| LaOBr: Tb3+ | 420 | 20 | 49.3 | 38.92 | 6.3 | Tetragonal | N |
| Y2O2S: Tb3+ | 420 | 18 | 34.9 | 17.04 | 4.9 | Hexgonal | N |
| Lu2SiO5: Ce3+ | 420 | | | | | | N |
| Lu1.8 Y0.2SiO5: Ce | 420 | | | | | | N |
| ZnS: Ag | 450 | 17 | 26.7 | 9.66 | 3.9 | Hexgonal | N |
| CdWO4 | 475 | | | | | | Slightly |
| Bi4Ge3O12 (BGO) | 480 | | | | | | N |
| (Zn,Cd)S: Ag | 530 | 19 | 38.4 | 9.66/26.7 | 4.8 | Hexgonal | N |
| Gd2O2S: Tb3+ | 545 | 13 | 59.5 | 50.22 | 7.3 | Hexgonal | N |
| La2O2S: Tb3+ | 545 | 12.5 | 52.6 | 38.92 | 6.5 | Hexgonal | N |
| Y3Al5O12 (Ce) | 550 | | | | | | N |
| LaOBr: Tm3+ | 360, 460 | 14 | 49.3 | 38.92 | 6.3 | Tetragonal | N |
| CaF2(Eu) | 435/300 | | | | | | N |

In one embodiment, phosphors used in the invention as energy converters can include phosphor particles, ionic doped phosphor particles, single crystal or poly-crystalline powders, single crystal or poly-crystalline monoliths, scintillator particles, a metallic shell encapsulating at least a fraction of a surface of the phosphors, a semiconductor shell encapsulating at least a fraction of a surface of the phosphors, and an insulator shell encapsulating at least a fraction of a surface of the phosphors, and phosphors of a distributed particle size.

Biocompatibility can be accomplished by coating with 1 or more layers or coatings of different types (ethyl cellulose, diamond, diamond-like carbon, etc). These coatings can be applied using standard techniques known to those of ordinary skill in the art.

In one embodiment, the upconverter structures of the invention are complexed with the X-ray down converting particles or other energy converters permitting for example X-ray irradiation to also assist in this process. In one embodiment, the X-ray down converting particles or other energy converters or metallic structures described herein permit X-ray irradiation to be used alone or in combination with the up converting particles.

In one embodiment, the color enhancing/energy augmentation structures noted above are integrally included with the up converting or down converting particles. In one embodiment, the color enhancing/energy augmentation structures noted above are attached as a sheet or cover over or under the up converting or down converting particles. In one embodiment, the color enhancing/energy augmentation structures noted above are attached as a sheet the up converting or down converting materials deposited in a vicinity of the intensified electric fields.

In another embodiment, noted above, the color enhancing/energy augmentation structures could include mechano-luminescent structures, and application of ultrasonic energy to the mechano-luminescent structures would change the color emission from a surface. Such applications could be used in security systems where an item would contain a pattern of the composite mechano-luminescent emitters. The pattern would not be apparent until it was activated with ultrasonic or acoustic energy upon which time light of a predetermined wavelength would be emitted. The light emitted might be visible or infrared light depending on the type of detector used to detect the emitted light. The following are exemplary embodiments of the present invention:

Embodiment 1. A method for security marking of an article, comprising:
providing a marking composition comprising one or more energy converters which emit UV and/or visible light upon interaction with an applied external energy, and, optionally, a carrier; and applying the marking composition onto at least a part of a surface of the article.

Embodiment 2. The method of Embodiment 1, further comprising evaporation of a solvent in an organic composition contacting the energy converter.

Embodiment 3. The method of Embodiment 1 or 2 further comprising evaporation of a solvent in an organic composition contacting the energy converter.

Embodiment 4. The method of any one of Embodiments 1-3, wherein the one or more energy converters are rendered biocompatible by one or more biocompatible coatings, wherein the one or more energy converters are rendered biocompatible by one or more biocompatible coatings.

Embodiment 5. The method of Embodiment 4, wherein the one or more biocompatible coatings are selected from the group consisting of ethyl cellulose, diamond, diamond-like carbon, and combinations thereof.

Embodiment 6. The method of any one of Embodiments 1-5, wherein the dispensing is performed in a defined pattern on the surface of the article.

Embodiment 7. The method of Embodiment 6, wherein the defined pattern comprises a single spot or a plurality of spots arranged on the surface of the article in a desired manner.

Embodiment 8. The method of Embodiment 6, wherein the defined pattern is in a form of a bar code marking, containing information about the article encoded within the bar code marking.

Embodiment 9. The method of any one of Embodiments 1-8, wherein the article is a pharmaceutical drug.

Embodiment 10. The method of Embodiment 9, wherein the pharmaceutical drug is in a form of a caplet or tablet.

Embodiment 11. The method of Embodiment 9, wherein the pharmaceutical drug is in a form of a capsule or gel capsule.

Embodiment 12. The method of any one of Embodiments 1-8, wherein the article is a container for a pharmaceutical drug.

Embodiment 13. The method of Embodiment 12, wherein the container is a pill bottle formed of plastic or glass.

Embodiment 14. The method of Embodiment 13, wherein the article is a cap of the container for a pharmaceutical.

Embodiment 15. The method of any one of Embodiments 1-8, wherein the article is a sealing structure for a container for a pharmaceutical.

Embodiment 16. The method of any one of Embodiments 1-8, wherein the article is a shipping container.

Embodiment 17. The method of any one of Embodiments 1-8, wherein the article is a box or shrinkwrap for packaging.

Embodiment 18. The method of any one of Embodiments 1-8, wherein the article is clothing, shoes, fashion accessories, or a handbag.

Embodiment 19. The method of any one of Embodiments 1-8, wherein the article is a credit card.

Embodiment 20. The method of any one of Embodiments 1-19, wherein the one or more energy converters is a single energy converter.

Embodiment 21. The method of any one of Embodiments 1-19, wherein the one or more energy converters are a plurality of energy converters having a combined UV and/or visible and/or IR emission with a defined and unique frequency signature enabling definitive identification.

Embodiment 22. The method of Embodiment 21, wherein the plurality of energy converters are spaced apart from one another on the article.

Embodiment 23. The method of Embodiment 21, wherein the plurality of energy converters are arranged at a same location on the article such that the plurality of energy converters are configured to emit a wavelength spectrum upon exposure to the applied external energy.

Embodiment 24. The method of any one of Embodiments 1-23, wherein at least one of the one or more energy converters exhibits elongated phosphorescence.

Embodiment 25. The method of any one of Embodiments 1-24, wherein the one or more energy converters are at least one member selected from the group consisting of fluorescent agents, phosphorescent agents, luminescent agents.

Embodiment 26. The method of any one of Embodiments 1-25, wherein at least one of the one or more energy converters comprises gas-filled capsules which respond to applied microwave or RF fields by generation of a light emitting plasma.

Embodiment 27. A method for security marking of a pharmaceutical drug in a gel capsule form, comprising:
providing a marking composition comprising one or more energy converters which emit UV and/or visible light and/or IR ion interaction with an applied external energy, and, optionally, a carrier; wherein the one or more energy converters are coated with one or more biocompatible inert coatings; and
adding an effective marking amount of the marking composition to the pharmaceutical drug in liquid form within the gel capsule.

Embodiment 28. A method for security marking of an article, comprising:
providing a plurality of marking compositions each comprising an energy converter which emits UV and/or visible light upon interaction with an applied external energy, and, optionally, a carrier; wherein the plurality of marking compositions are configured to provide emissions distinguishable one from the other; and
applying the plurality of marking compositions individually onto at least a part of a surface of the article in a two-dimensional and/or 3D matrix, wherein each position in the matrix provides at least one piece of information selected from the group consisting of product properties, manufacturing data, packaging properties, and product identity, when combined with a primary emission wavelength from the marking composition applied therein.

Embodiment 29. The method of Embodiment 28, wherein the article is a pharmaceutical drug, a container, a pill bottle, a cap for a container, sealing structure for a container, a shipping container, a package, a box, shrinkwrap for packaging, clothing, shoes, a fashion accessory, a handbag, a credit card, or a shipping label.

Embodiment 30. A method for security marking of a product to assist detection of product tampering and/or product counterfeiting, comprising:
providing a marking composition comprising one or more energy converters which emit UV and/or visible light upon interaction with an applied external energy, and, optionally, a carrier; and
applying the marking composition to at least one member selected from the group consisting of shrinkwrap coverings, seals for a container opening, packaging containers, and container closures.

Embodiment 31. A method for security marking of a product to assist detection of product tampering and/or product counterfeiting, comprising:
providing one or more energy converters which emit UV and/or visible light upon interaction with an applied external energy in admixture with a material used to form at least one structure selected from the group consisting of shrinkwrap coverings, seals for a container opening, packaging containers, and container closures; and
forming the material into at least one structure selected from the group consisting of shrinkwrap coverings, seals for a container opening, packaging containers, and container closures, such that the one or more energy converters are distributed throughout the material forming the at least one structure.

Embodiment 32. A method for increasing security of a credit card, comprising:
forming the credit card, wherein the credit card body comprises a material comprising plastic or metal and a magnetic strip on a portion of the credit card body, wherein the magnetic strip contains identifying information regarding the credit card account;
wherein at least a portion of the credit card body or magnetic strip further comprises one or more energy converters which emit UV and/or visible light upon interaction with an applied external energy, such that the emitted UV and/or visible light provides an additional identifying security signature associated with the credit card account.

Embodiment 33. The method of Embodiment 32, wherein the one or more energy converters are present in a coating on a surface of the credit card body or magnetic strip.

Embodiment 34. The method of Embodiment 32, wherein the one or more energy converters are incorporated into the material forming the credit card body or into the magnetic strip.

Embodiment 35. The method of Embodiment 32, wherein the one or more energy converters are incorporated into an electronics chip embedded in the credit card body.

Embodiment 36. A marked article formed by the method of any one of Embodiments 1-26.

Embodiment 37. A marked pharmaceutical drug in gel capsule form formed by the method of Embodiment 27.

Embodiment 38. A marked article formed by the method of any one of Embodiments 28-29.

Embodiment 39. A marked product formed by the method of Embodiment 30.

Embodiment 40. A marked product formed by the method of Embodiment 31.

Embodiment 41. A credit card formed by the method of Embodiment 32.

Embodiment 42. A method for security marking of a pharmaceutical drug in a liquid form, comprising:
providing a marking composition comprising one or more energy converters which emit UV and/or visible light and/or IR ion interaction with an applied external energy, and, optionally, a carrier; wherein the one or more energy converters are coated with one or more biocompatible inert coatings;
adding an effective marking amount of the marking composition to the pharmaceutical drug in liquid form.

Embodiment 43. A method for security marking of an article, comprising:
determining a desired pattern of marking compositions to encode an article with desired information, the marking compositions comprising one or more energy converters which emit UV and/or visible light upon interaction with an applied external energy;
selecting the appropriate energy converters for the marking compositions to achieve the desired pattern comprising the desired information;
applying the appropriate energy converters in the desired pattern to mark the article with the pattern of marking compositions; and
applying external energy to the article and reading the emitted light information from the marking compositions to verify that the desired pattern of marking compositions conveys the desired information.

Embodiment 44. The method of Embodiment 43, wherein the article is a pharmaceutical drug, a container, a pill bottle, a cap for a container, sealing structure for a container, a shipping container, a package, a box, shrinkwrap for packaging, clothing, shoes, a fashion accessory, a handbag, a credit card, or a shipping label.

Embodiment 45. The method of any one of Embodiments 43-44, wherein the desired pattern comprises multiple energy converters arranged at a same location on the article, and wherein the emitted light information is a spectrum of wavelengths that corresponds to the desired information.

Embodiment 46. The method of any one of Embodiments 43-45, wherein the emitted light information is read and processed by a scanning device comprising a spectrometer.

Embodiment 47. The method of any one of Embodiments 43-46, wherein the step of applying the appropriate energy converters comprises:
dispersing the appropriate energy converters in a solvent to form an application mixture;
applying the application mixture to the article in the desired pattern; and
evaporating the solvent from the application mixture such that the appropriate energy converters are left behind on the article.

Embodiment 48. The method of any one of Embodiments 43-47, wherein the emitted light information is based on the decay in glow of the marking compositions after the external energy is terminated.

Embodiment 49. A method for marking articles within a container for identification, the method comprising:
providing multiple articles to be arranged within a container;
applying a marking composition to each article, wherein the marking composition comprises one or more energy converters which emit UV and/or visible light upon interaction with an applied external energy, and, optionally, a carrier; and arranging the multiple articles in the container,
wherein the marking compositions on each article indicate information about each article.

Embodiment 50. The method of Embodiment 49, wherein the article is a pharmaceutical drug, a container, a pill bottle, a cap for a container, sealing structure for a container, a package, a box, shrinkwrap for packaging, clothing, shoes, a fashion accessory, a handbag, a credit card, or a shipping label.

Embodiment 51. The method of any one of Embodiments 49-50, wherein the marking compositions on each article indicate the location of the article within the container.

Embodiment 52. The method of any one of Embodiments 49-51, wherein each marking composition comprises a different marking composition.

Embodiment 53. The method of any one of Embodiments 49-53, wherein the articles are boxes and the container is a shipping container.

Embodiment 54. An identification label comprising:
a substrate;
one or more marking compositions on the substrate, wherein the marking composition comprises one or more energy converters which emit UV and/or visible light upon interaction with an applied external energy, wherein the one or more marking compositions are arranged in a specific pattern at a specific location on the substrate to convey desired information on the substrate.

Embodiment 55. The identification label of Embodiment 54, wherein the substrate is arranged in a cylindrical form and is configured to attach to a tag for connection to a product.

Embodiment 56. The identification label of any one of Embodiments 54-55, wherein the substrate comprises paper, foil, and/or an adhesive.

Embodiment 57. A product comprising the identification label of any one of Embodiments 54-56, wherein the identification label provides information about the product.

Embodiment 58. The identification label of any one of Embodiments 54-56, further comprising an RFID chip, antennae, and/or circuitry.

Obviously, numerous modifications and variations of the present invention are possible in light of the above teachings. It is therefore to be understood that within the scope of the appended claims, the invention may be practiced otherwise than as specifically described herein.

1. A method for security marking of an article, comprising:
providing a marking composition comprising one or more energy converters which emit UV and/or visible light upon interaction with an applied external energy, and, optionally, a carrier; and
applying the marking composition onto at least a part of a surface of the article.

2. The method of claim 1, further comprising evaporation of a solvent in an organic composition contacting the energy converter.

3. The method of claim 1, wherein the one or more energy converters are biocompatible.

4. The method of claim 3, wherein the one or more energy converters are rendered biocompatible by one or more biocompatible coatings.

5. The method of claim 4, wherein the one or more biocompatible coatings are selected from the group consisting of ethyl cellulose, diamond, diamond-like carbon, and combinations thereof.

6. The method of claim 1, wherein the dispensing is performed in a defined pattern on the surface of the article.

7. The method of claim 6, wherein the defined pattern comprises a single spot or a plurality of spots arranged on the surface of the article in a desired manner.

8. The method of claim 6, wherein the defined pattern is in a form of a bar code marking, containing information about the article encoded within the bar code marking.

9. The method of claim 1, wherein the article is a pharmaceutical drug.

10. The method of claim 9, wherein the pharmaceutical drug is in a form of a caplet or tablet.

11. The method of claim 9, wherein the pharmaceutical drug is in a form of a capsule or gel capsule.

12. The method of claim 1, wherein the article is a container for a pharmaceutical drug.

13. The method of claim 12, wherein the container is a pill bottle formed of plastic or glass.

14. The method of claim 13, wherein the article is a cap of the container for a pharmaceutical.

15. The method of claim 1, wherein the article is a sealing structure for a container for a pharmaceutical.

16. The method of claim 1, wherein the article is a shipping container.

17. The method of claim 1, wherein the article is a box or shrinkwrap for packaging.

18. The method of claim 1, wherein the article is clothing, shoes, fashion accessories, or a handbag.

19. The method of claim 1, wherein the article is a credit card.

20. The method of claim 1, wherein the one or more energy converters is a single energy converter.

21. The method of claim 1, wherein the one or more energy converters are a plurality of energy converters having a combined UV and/or visible and/or IR emission with a defined and unique frequency signature enabling definitive identification.

22. The method of claim 21, wherein the plurality of energy converters are spaced apart from one another on the article.

23. The method of claim 21, wherein the plurality of energy converters are arranged at a same location on the article such that the plurality of energy converters are configured to emit a wavelength spectrum upon exposure to the applied external energy.

24. The method of claim 1, wherein at least one of the one or more energy converters exhibits elongated phosphorescence.

25. The method of claim 1, wherein the one or more energy converters are at least one member selected from the group consisting of fluorescent agents, phosphorescent agents, luminescent agents.

26. The method of claim 1, wherein at least one of the one or more energy converters comprises gas-filled capsules which respond to applied microwave or RF fields by generation of a light emitting plasma.

27. A method for security marking of a pharmaceutical drug in a gel capsule form, comprising:
providing a marking composition comprising one or more energy converters which emit UV and/or visible light and/or IR ion interaction with an applied external energy, and, optionally, a carrier; wherein the one or more energy converters are coated with one or more biocompatible inert coatings; and
adding an effective marking amount of the marking composition to the pharmaceutical drug in liquid form within the gel capsule.

28. A method for security marking of an article, comprising:
providing a plurality of marking compositions each comprising an energy converter which emits UV and/or visible light upon interaction with an applied external energy, and, optionally, a carrier; wherein the plurality of marking compositions are configured to provide emissions distinguishable one from the other; and
applying the plurality of marking compositions individually onto at least a part of a surface of the article in a two-dimensional and/or 3D matrix, wherein each position in the matrix provides at least one piece of information selected from the group consisting of product properties, manufacturing data, packaging properties, and product identity, when combined with a primary emission wavelength from the marking composition applied therein.

29. The method of claim 28, wherein the article is a pharmaceutical drug, a container, a pill bottle, a cap for a container, sealing structure for a container, a shipping container, a package, a box, shrinkwrap for packaging, clothing, shoes, a fashion accessory, a handbag, a credit card, or a shipping label.

30. A method for security marking of a product to assist detection of product tampering and/or product counterfeiting, comprising:
providing a marking composition comprising one or more energy converters which emit UV and/or visible light upon interaction with an applied external energy, and, optionally, a carrier; and
applying the marking composition to at least one member selected from the group consisting of shrinkwrap coverings, seals for a container opening, packaging containers, and container closures.

31. A method for security marking of a product to assist detection of product tampering and/or product counterfeiting, comprising:
providing one or more energy converters which emit UV and/or visible light upon interaction with an applied external energy in admixture with a material used to form at least one structure selected from the group consisting of shrinkwrap coverings, seals for a container opening, packaging containers, and container closures; and
forming the material into at least one structure selected from the group consisting of shrinkwrap coverings, seals for a container opening, packaging containers, and container closures, such that the one or more energy converters are distributed throughout the material forming the at least one structure.

32. A method for increasing security of a credit card, comprising:
forming the credit card, wherein the credit card body comprises a material comprising plastic or metal and a magnetic strip on a portion of the credit card body, wherein the magnetic strip contains identifying information regarding the credit card account;
wherein at least a portion of the credit card body or magnetic strip further comprises one or more energy converters which emit UV and/or visible light upon interaction with an applied external energy, such that the emitted UV and/or visible light provides an additional identifying security signature associated with the credit card account.

33. The method of claim 32, wherein the one or more energy converters are present in a coating on a surface of the credit card body or magnetic strip.

34. The method of claim 32, wherein the one or more energy converters are incorporated into the material forming the credit card body or into the magnetic strip.

35. The method of claim 32, wherein the one or more energy converters are incorporated into an electronics chip embedded in the credit card body.

36. A marked article formed by the method of claim 1.

37. A marked pharmaceutical drug in gel capsule form formed by the method of claim 27.

38. A marked article formed by the method of claim 28.

39. A marked product formed by the method of claim 30.

40. A marked product formed by the method of claim 31.

41. A credit card formed by the method of claim 32.

42. A method for security marking of a pharmaceutical drug in a liquid form, comprising:
providing a marking composition comprising one or more energy converters which emit UV and/or visible light and/or IR ion interaction with an applied external energy, and, optionally, a carrier; wherein the one or more energy converters are coated with one or more biocompatible inert coatings;
adding an effective marking amount of the marking composition to the pharmaceutical drug in liquid form.

43. A method for security marking of an article, comprising:
determining a desired pattern of marking compositions to encode an article with desired information, the marking compositions comprising one or more energy converters which emit UV and/or visible light upon interaction with an applied external energy;
selecting the appropriate energy converters for the marking compositions to achieve the desired pattern comprising the desired information;
applying the appropriate energy converters in the desired pattern to mark the article with the pattern of marking compositions; and
applying external energy to the article and reading the emitted light information from the marking compositions to verify that the desired pattern of marking compositions conveys the desired information.

44. The method of claim 43, wherein the article is a pharmaceutical drug, a container, a pill bottle, a cap for a container, sealing structure for a container, a shipping container, a package, a box, shrinkwrap for packaging, clothing, shoes, a fashion accessory, a handbag, a credit card, or a shipping label.

45. The method of claim 43, wherein the desired pattern comprises multiple energy converters arranged at a same location on the article, and wherein the emitted light information is a spectrum of wavelengths that corresponds to the desired information.

46. The method of claim 43, wherein the emitted light information is read and processed by a scanning device comprising a spectrometer.

47. The method of claim 43, wherein the step of applying the appropriate energy converters comprises:
dispersing the appropriate energy converters in a solvent to form an application mixture;
applying the application mixture to the article in the desired pattern; and
evaporating the solvent from the application mixture such that the appropriate energy converters are left behind on the article.

48. The method of claim 43, wherein the emitted light information is based on the decay in glow of the marking compositions after the external energy is terminated.

49. A method for marking articles within a container for identification, the method comprising:
providing multiple articles to be arranged within a container;
applying a marking composition to each article, wherein the marking composition comprises one or more energy converters which emit UV and/or visible light upon interaction with an applied external energy, and, optionally, a carrier; and
arranging the multiple articles in the container,
wherein the marking compositions on each article indicate information about each article.

50. The method of claim 49, wherein the article is a pharmaceutical drug, a container, a pill bottle, a cap for a container, sealing structure for a container, a package, a box, shrinkwrap for packaging, clothing, shoes, a fashion accessory, a handbag, a credit card, or a shipping label.

51. The method of claim 49, wherein the marking compositions on each article indicate the location of the article within the container.

52. The method of claim 49, wherein each marking composition comprises a different marking composition.

53. The method of claim 49, wherein the articles are boxes and the container is a shipping container.

54. An identification label comprising:
a substrate;
one or more marking compositions on the substrate, wherein the marking composition comprises one or more energy converters which emit UV and/or visible light upon interaction with an applied external energy, wherein the one or more marking compositions are arranged in a specific pattern at a specific location on the substrate to convey desired information on the substrate.

55. The identification label of claim 54, wherein the substrate is arranged in a cylindrical form and is configured to attach to a tag for connection to a product.

56. The identification label of claim 54, wherein the substrate comprises paper, foil, and/or an adhesive.

57. A product comprising the identification label of claim 54, wherein the identification label provides information about the product.

58. The identification label of claim 54, further comprising an RFID chip, antennae, and/or circuitry.
